(19) United States
(12) Patent Application Publication
(10) Pub. No.: US 2026/0066299 A1
(43) Pub. Date: Mar. 5, 2026

(54) SALT-PHILIC SOLVENT-PHOBIC (SP2) INTERFACIAL COATING FOR ANODES

(71) Applicant: The Board of Trustees of the Leland Stanford Junior University, Stanford, CA (US)

(72) Inventors: Zhenan BAO, Stanford, CA (US); Yi CUI, Stanford, CA (US); Zhuojun HUANG, Stanford, CA (US); Jiancheng LAI, Stanford, CA (US)

(73) Assignee: The Board of Trustees of the Leland Stanford Junior University, Stanford, CA (US)

(21) Appl. No.: 19/106,999

(22) PCT Filed: Aug. 30, 2023
(86) PCT No.: PCT/US2023/073203

§ 371 Date: Feb. 26, 2025

Related U.S. Application Data
(60) Provisional application No. 63/402,427, filed on Aug. 30, 2022.

(51) Int. Cl. H01M 4/62; C08G 77/385; C08G 77/388; C09D 183/08; H01M 4/02

(52) U.S. Cl. CPC H01M 4/62; C08G 77/385; C08G 77/388; C09D 183/08; H01M 2004/027

(57) ABSTRACT

A salt-philic solvent-phobic (SP2) polymer coating on a lithium anode, sodium anode, or a silicon anode selectively transports salt over solvent and is configured to promote salt-derived SEI formation on the anode. The SP2 coating can include a polymer backbone, a first side chain comprising a first moiety having salt affinity, and a second side chain comprising a second moiety immiscible with polar aprotic solvents.

### CROSS REFERENCE TO RELATED APPLICATIONS

This application claims the benefit of priority to U.S. Provisional Patent Application No. 63/402,427 filed Aug. 30, 2022, which is hereby incorporated by reference, in its entirety for any and all purposes.

### STATEMENT OF GOVERNMENT SPONSORED RESEARCH

This invention was made with Government support under DOE Battery 500 Contract Nos. DE-AC05-76RL01830 and DE-AC02-76SF00515 awarded by the United States Department of Energy. The Government has certain rights in the invention.

### TECHNICAL FIELD

The present technology generally relates to energy storage and more particularly to a salt-philic solvent-phobic (SP²) interfacial coating for lithium metal anodes, sodium metal anodes, and silicon anodes.

### SUMMARY

The present technology generally relates to a strategy to promote the formation of a salt-derived solid electrolyte interphase (SEI), which may be more robust and stable than a solvent-derived SEI. More particularly, the present embodiments relate to a salt-philic solvent-phobic (SP²) polymer coating on Li and/or Si anodes that preferentially transports salt over solvent and thus promotes salt-derived SEI formation. Unlike previously reported artificial SEIs, this SP² coating resulted in enhancement of cycling performance in several different electrolyte solvents, including ether, carbonate, and fluorinated ether.

In one aspect, an SP² polymer coating on an anode is disclosed. The anode includes lithium, sodium, silicon, or a mixture of any two or more thereof. The SP² polymer selectively transports salt over solvent and is configured to promote salt-derived SEI formation.

The SP² polymer coating may result in enhancement of cycling performance in solvents including ether, carbonate, fluorinated ether, and mixtures of any two or more thereof. The polymer coating may include a polymer backbone including polysiloxane, polyether, polyacrylate, or a combination of any two or more thereof. In some embodiments, the polymer coating may include first sidechains on the polymer backbone, the first sidechains having salt affinity to promote salt transport. The first sidechains may comprise:

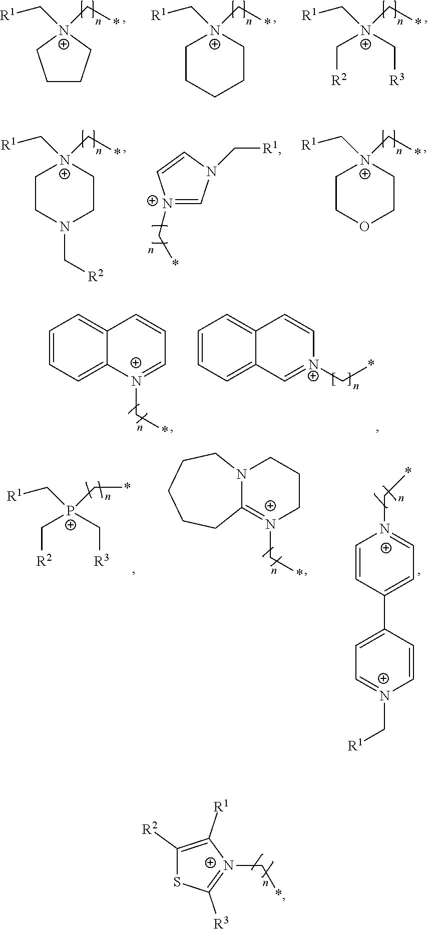

or a mixture of any two or more thereof. In the structures above, * indicates a point of connection to the polymer backbone; R¹, R², and R³ are each independently hydrogen, fluoride, an alkyl chain, or a fluorinated alkyl chain; and n is 1 to 100. The first sidechains may comprise:

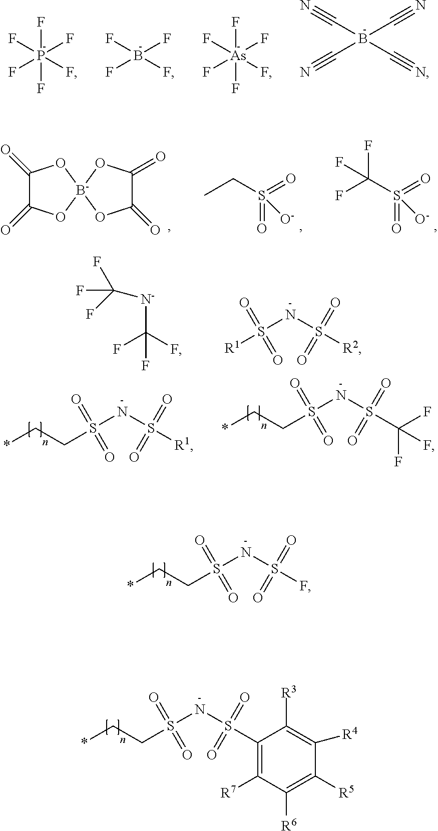

or a mixture of any two or more thereof. In the structures above, * indicates a point of connection to the polymer backbone; R¹ and R² are independently F, a C₁-C₁₀ alkyl chain, a C₁-C₁₀ fluorinated alkyl chain, or an aryl group; R³ to R⁷ are independently F, a C₁-C₁₀ alkyl chain, or a C₁-C₁₀ fluorinated alkyl chain; and n is 1 to 100.

In some embodiments, the polymer coating may include second sidechains on the polymer backbone, the second sidechains being immiscible with polar aprotic solvents. In some embodiments, the second sidechains may include alkyl chains, fluorinated alkyl chains, ether, carbonate, or a combination thereof. In some embodiments, the second sidechains may include 1,1,1,2,2,3,3,4,4-nonafluoro-6-propoxyhexane, hexane, or a combination thereof.

In another aspect, an electrochemical cell includes an electrolyte including a lithium salt, a sodium salt, or a mixture thereof; an anode comprising silicon, lithium, sodium, or a mixture thereof; and a polymer coating disposed on the anode. The polymer coating may include a polymer backbone, a first side chain having a first moiety having salt affinity, and a second side chain having a second moiety immiscible with polar aprotic solvents.

In some embodiments, the lithium salt may include lithium bis-trifluoromethanesulfonimide (LiTFSI), lithium bis(fluorosulfonyl)imide (LiFSI), lithium hexafluorophosphate (LiPF₆), lithium tetrafluoroborate (LiBF₄), lithium bis(oxalato)borate (LiBOB), or a mixture of any two or more thereof.

In another aspect, a method of preparing a coating on a lithium anode, a sodium anode, or a silicon anode is disclosed. The method includes spin coating or drip coating the lithium anode, sodium anode, or the silicon anode with a polymer dissolved in a solvent, and, after the spin coating or the drip coating, drying the lithium anode, the sodium anode, or the silicon anode. The polymer may include a polymer backbone; a first side chain having a first moiety having salt affinity; and a second side chain having a second moiety immiscible with polar aprotic solvents.

### BRIEF DESCRIPTION OF THE DRAWINGS

FIG. 1 is an illustration of how a SP² polymer coating on Li metal anode may induce the formation of salt derived SEI.

FIGS. 2A-2C characterize salt affinity and solvent phobicity of polymer coatings. FIG. 2A shows chemical structures and a comparison of their salt/solvent interaction with different sidechains. FIG. 2B is a graph of the polymer side chain salt affinity from DFT calculations where * indicates salt affinity was not detected. FIG. 2C is a graph of contact angle measurements on polymer-coated Si wafers with three types of solvents (a mixture of dioxolane (“DOL”) and dimethoxyethane (“DME”); a mixture of ethylene carbonate (“EC”), diethyl carbonate (“DEC”), and fluoroethylene carbonate (“FEC”); and 2,2,3,3-tetrafluoro-1,4-dimethoxybutane (“FDMB”)), according to various embodiments.

FIGS. 3A-3F characterize selectivity of pyrrolidinium bis(trifluoromethylsulfonyl) imide (“PyTFSI”) and an SP² polymer with perfluorinated sidechains (“SP²_{perF}”). FIG. 3A illustrates the experimental set-up for H-cell experiments. FIG. 3B illustrates the H-cell experimental results with the blue dots representing the LiTFSI salt concentration and salt concentration values listed below. FIG. 3C is a graph of rheological frequency sweep of a polymer with PyTFSI sidechains before (circle) and after (square) being soaked in DME solvent for 8 hours, with the tan (delta) at 10 rad s⁻¹ marked. FIG. 3D is a graph of rheological frequency sweep of SP²_{perF} polymer before (circle) and after (square) being soaked in DME solvent for 8 hours, with the tan (delta) at 10 rad s⁻¹ marked. FIG. 3E is a graph of conductivity at 25° C. of polymer with PyTFSI sidechains and SP²_{perF} polymer before and after being soaked in DME solvent for 8 hours. FIG. 3F shows X-ray photoelectron spectroscopy (“XPS”) graphs of oxygen O1s peaks of SEI layers formed on Li anodes (from left to right: bare, coated with polymer with PyTFSI sidechains, and coated SP²_{perF} polymer, respectively) with signals attributed to either salt or solvent decomposition and their relative percentage values noted.

FIGS. 4A-4E show electrochemical characterization of SP²_{perF} with different electrolytes. FIG. 4A is a graph of coulombic efficiency (“C.E.”) of SP²_{perF} polymer-coated Cu in Li|Cu cells with 40 μL of ether-based electrolyte (1 M LiTFSI in DOL/DME with 1 wt. % LiNO₃), carbonate-based electrolyte (1 M LiPF₆ in EC/DEC with 10% FEC), and FDMB-based electrolyte (1 M LiFSI in FDMB). FIG. 4B shows graphs of time-dependent electrochemical impedance spectroscopy (EIS) measurements with SP²_{perF} coated Li|Li symmetric cells in either carbonate-based (top) or FDMB-based (bottom) electrolytes. FIG. 4C is a graph of impedance increase (%) over 100 hours calculated from the EIS measurements in FIG. 4B. FIG. 4D shows graphs of voltage measurements while cycling Li|Li symmetric cells with or without SP²_{perF} coatings in carbonate-based (left) or FDMB-based (right) electrolytes. FIG. 4E show scanning electron microscopy (SEM) top view images of Li deposited on SP²_{perF} polymer-coated Cu (left) and bare Cu (right) electrodes in carbonate-based electrolyte, with a scale bar of 10 μm.

FIGS. 5A-5I show cycling of SP²_{perF}-coated Li anodes in Li|NMC cells. FIG. 5A is a graph of rate capability with carbonate-based electrolyte. FIG. 5B is a graph of rate capability with FDMB-based electrolyte. FIG. 5C is a graph of long-term cycling with carbonate-based electrolyte. FIG. 5D is a graph of long-term cycling with FDMB-based electrolyte. FIG. 5E is a comparison of cycle life (80% capacity retention) plotted against accessible lithium amount of the SP²_{perF} coating as compared to other coatings and electrolytes, where the X-axis locations of points 4, 5, 7, 11, and 12 are at 10 mAh cm⁻² and are adjusted slightly for visualization. FIG. 5F is a graph of Coulombic efficiency (C.E.) of Li|NMC cells with coated or bare Li anodes in carbonate-based electrolyte. FIG. 5G is a graph of C.E. of Li|NMC cells with coated or bare Li anodes in FDMB-based electrolyte. FIG. 5H is a graph of long-term cycling of Li|NMC cells with higher cathode loading and FDMB-based electrolyte. FIG. 5I is a graph of discharge capacity of Li|NMC cells with coated or bare Li anodes cycled in carbonate-based electrolyte.

FIGS. 6A and 6B show reaction schemes for the synthesis of SP² polymers. FIG. 6A shows a reaction scheme for SP²_{perF} polymer. FIG. 6B shows a reaction scheme for SP²_{alkyl} polymer.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

### Definitions

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an organic group as defined below (e.g., an alkyl group) in which one or more bonds to a hydrogen atom contained therein are replaced by a bond to non-hydrogen and/or non-carbon atoms. Substituted groups also include groups in which one or more bonds to a carbon(s) or hydrogen(s) atom are replaced by one or more bonds, including double or triple bonds, to a heteroatom. Thus, a substituted group is substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, aryloxy, aralkyloxy, heterocyclyl, heterocyclylalkyl, heterocyclyloxy, and heterocyclylalkoxy groups; carbonyls (oxo); carboxylates; esters; urethanes; oximes; hydroxylamines; alkoxyamines; aralkoxyamines; thiols; sulfides; sulfoxides; sulfones; sulfonyls; pentafluorosulfanyl (i.e., SFs), sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; and nitriles (i.e., CN).

Substituted ring groups such as substituted cycloalkyl, aryl, heterocyclyl and heteroaryl groups also include rings and ring systems in which a bond to a hydrogen atom is replaced with a bond to a carbon atom. Therefore, substituted cycloalkyl, aryl, heterocyclyl and heteroaryl groups may also be substituted with substituted or unsubstituted alkyl, alkenyl, and alkynyl groups as defined below.

The term “alkyl,” by itself or as part of another substituent, means, unless otherwise stated, a saturated monovalent hydrocarbon radical, having, in some embodiments, one to fifty (e.g., C₁-C₅₀ alkyl), or one to twelve (e.g., C₁-C₁₂ alkyl), or one to ten carbon atoms (e.g., C₁-C₁₀ alkyl), respectively. The term “alkyl” encompasses straight and branched-chain hydrocarbon groups. Examples of alkyl groups include, but are not limited to, methyl, ethyl, n-propyl, isopropyl, n-butyl, t-butyl, isobutyl, sec-butyl, isopentyl, tert-pentyl, n-pentyl, isohexyl, n-hexyl, n-heptyl, 4-isopropylheptane, n-octyl, and the like. In some embodiments, the alkyl groups are C₁-C₃ alkyl groups (e.g., methyl, ethyl, or isopropyl).

Alkenyl groups include straight and branched chain alkyl groups as defined above, except that at least one double bond exists between two carbon atoms. Alkenyl groups may be substituted or unsubstituted. Alkenyl groups have from 2 to 12 carbon atoms, and typically from 2 to 10 carbons or, in some embodiments, from 2 to 8, 2 to 6, or 2 to 4 carbon atoms. In some embodiments, the alkenyl group has one, two, or three carbon-carbon double bonds. Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═CH₂, among others. Representative substituted alkenyl groups may be mono-substituted or substituted more than once, such as, but not limited to, mono-, di- or tri-substituted with substituents such as those listed above.

The term “alkylene” refers to a straight or branched, saturated, hydrocarbon radical having, in some embodiments, one to six (e.g., C₁-C₆ alkylene), or one to four (e.g., C₁-C₄ alkylene), or one to three (e.g., C₁-C₃ alkylene), or one to two (e.g., C₁-C₂ alkylene) carbon atoms, and linking at least two other groups, i.e., a divalent hydrocarbon radical. When two moieties are linked to the alkylene they can be linked to the same carbon atom (i.e., geminal), or different carbon atoms of the alkylene group. For instance, a straight chain alkylene can be the bivalent radical of —(CH₂)ₙ—, where n is 1, 2, 3, 4, 5 or 6 (i.e., a C₁-C₆ alkylene). Representative alkylene groups include, but are not limited to, methylene, ethylene, propylene, isopropylene, butylene, isobutylene, secbutylene, pentylene, hexylene and the like. In some embodiments, the alkylene groups are C₁-C₃ alkylene groups (e.g., methylene, ethylene, or propylene).

As used herein, the term “alkoxy” refers to an alkyl group, as defined herein, that is attached to the remainder of the molecule via an oxygen atom (e.g., —O—C₁-C₁₂ alkyl, —O—C₁-C₈ alkyl, —O—C₁-C₆ alkyl, or —O—C₁-C₃ alkyl). Non-limiting examples of alkoxy groups include methoxy, ethoxy, n-propoxy, iso-propoxy, n-butoxy, sec-butoxy, n-pentoxy, n-hexoxy, and the like. In some embodiments, the alkoxy groups are C₁-C₆ alkoxy groups (e.g., methoxy, ethoxy, n-propoxy, iso-propoxy, butoxy, pentoxy, or hexyloxy).

Alkynyl groups include straight and branched chain alkyl groups as defined above, except that at least one triple bond exists between two carbon atoms. Alkynyl groups may be substituted or unsubstituted. Alkynyl groups have from 2 to 12 carbon atoms, and typically from 2 to 10 carbons or, in some embodiments, from 2 to 8, 2 to 6, or 2 to 4 carbon atoms. In some embodiments, the alkynyl group has one, two, or three carbon-carbon triple bonds. Examples include, but are not limited to —C≡CH, —C≡CCH₃, —CH₂C≡CCH₃, and —C≡CCH₂CH(CH₂CH₃)₂, among others.

Aryl groups are cyclic aromatic hydrocarbons that do not contain heteroatoms. Aryl groups herein include monocyclic, bicyclic and tricyclic ring systems. Aryl groups may be substituted or unsubstituted. Thus, aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups are phenyl or naphthyl. The phrase “aryl groups” includes groups containing fused rings, such as fused aromatic-aliphatic ring systems (e.g., indanyl, tetrahydronaphthyl, and the like). Representative substituted aryl groups may be mono-substituted (e.g., tolyl) or substituted more than once. For example, monosubstituted aryl groups include, but are not limited to, 2-, 3-, 4-, 5-, or 6-substituted phenyl or naphthyl groups, which may be substituted with substituents such as those listed above.

The term “cycloalkyl” refers to a monocyclic, bicyclic or polycyclic hydrocarbon ring system having, in some embodiments, 3 to 14 carbon atoms (e.g., C₃-C₁₄ cycloalkyl), or 3 to 10 carbon atoms (e.g., C₃-C₁₀ cycloalkyl), or 3 to 8 carbon atoms (e.g., C₃-C₈ cycloalkyl), or 3 to 6 carbon atoms (e.g., C₃-C₆ cycloalkyl) or 5 to 6 carbon atoms (e.g., C₅-C₆ cycloalkyl). Cycloalkyl groups can be saturated or characterized by one or more points of unsaturation (i.e., carbon-carbon double and/or triple bonds), provided that the points of unsaturation do not result in an aromatic system. Examples of monocyclic cycloalkyl groups include, but are not limited to, cyclopropyl, cyclobutyl, cyclopentyl, cyclohexyl, cyclohexeneyl, cyclohexynyl, cycloheptyl, cyclohepteneyl, cycloheptadieneyl, cyclooctyl, cycloocteneyl, cyclooctadieneyl, and the like. The rings of bicyclic and polycyclic cycloalkyl groups can be fused, bridged, or spirocyclic. Non-limiting examples of bicyclic, spirocyclic and polycyclic hydrocarbon groups include bicyclo[2.2.1]heptane, bicyclo[2.2.2]octane, adamantyl, indanyl, spiro[5.5]undecane, spiro[2.2]pentane, spiro[2.2]pentadiene, spiro[2.5]octane, spiro[2.2]pentadiene, and the like. In some embodiments, the cycloalkyl groups of the present disclosure are monocyclic C₃-C₇ cycloalkyl moieties (e.g., cyclopropyl, cyclobutyl, cyclopentyl, cyclohexyl, or cycloheptyl).

Cycloalkylalkyl groups are alkyl groups as defined above in which a hydrogen or carbon bond of an alkyl group is replaced with a bond to a cycloalkyl group as defined above. Cycloalkylalkyl groups may be substituted or unsubstituted. In some embodiments, cycloalkylalkyl groups have from 4 to 16 carbon atoms, 4 to 12 carbon atoms, and typically 4 to 10 carbon atoms. Substituted cycloalkylalkyl groups may be substituted at the alkyl, the cycloalkyl or both the alkyl and cycloalkyl portions of the group. Representative substituted cycloalkylalkyl groups may be mono-substituted or substituted more than once, such as, but not limited to, mono-, di- or tri-substituted with substituents such as those listed above.

Cycloalkenyl groups include cycloalkyl groups as defined above, having at least one double bond between two carbon atoms. Cycloalkenyl groups may be substituted or unsubstituted. In some embodiments the cycloalkenyl group may have one, two or three double bonds but does not include aromatic compounds. Cycloalkenyl groups have from 4 to 14 carbon atoms, or, in some embodiments, 5 to 14 carbon atoms, 5 to 10 carbon atoms, or even 5, 6, 7, or 8 carbon atoms. Examples of cycloalkenyl groups include cyclohexenyl, cyclopentenyl, cyclohexadienyl, cyclobutadienyl, and cyclopentadienyl.

Cycloalkenylalkyl groups are alkyl groups as defined above in which a hydrogen or carbon bond of the alkyl group is replaced with a bond to a cycloalkenyl group as defined above. Cycloalkenylalkyl groups may be substituted or unsubstituted. Substituted cycloalkenylalkyl groups may be substituted at the alkyl, the cycloalkenyl or both the alkyl and cycloalkenyl portions of the group. Representative substituted cycloalkenylalkyl groups may be substituted one or more times with substituents such as those listed above.

Heterocyclyl groups include aromatic (also referred to as heteroaryl) and non-aromatic ring compounds containing 3 or more ring members, of which one or more is a heteroatom such as, but not limited to, N, O, and S. Heterocyclyl groups may be substituted or unsubstituted. In some embodiments, the heterocyclyl group contains 1, 2, 3 or 4 heteroatoms. In some embodiments, heterocyclyl groups include mono-, bi- and tricyclic rings having 3 to 16 ring members, whereas other such groups have 3 to 6, 3 to 10, 3 to 12, or 3 to 14 ring members. Heterocyclyl groups encompass aromatic, partially unsaturated and saturated ring systems, such as, for example, imidazolyl, imidazolinyl and imidazolidinyl groups. The phrase “heterocyclyl group” includes fused ring species including those comprising fused aromatic and non-aromatic groups, such as, for example, benzotriazolyl, 2,3-dihydrobenzo[1,4]dioxinyl, and benzo[1,3]dioxolyl. The phrase also includes bridged polycyclic ring systems containing a heteroatom such as, but not limited to, quinuclidyl. The phrase includes heterocyclyl groups that have other groups, such as alkyl, oxo or halo groups, bonded to one of the ring members, referred to as “substituted heterocyclyl groups.” Heterocyclyl groups include, but are not limited to, aziridinyl, azetidinyl, pyrrolidinyl, imidazolidinyl, pyrazolidinyl, thiazolidinyl, tetrahydrothiophenyl, tetrahydrofuranyl, dioxolyl, furanyl, thiophenyl, pyrrolyl, pyrrolinyl, imidazolyl, imidazolinyl, pyrazolyl, pyrazolinyl, triazolyl, tetrazolyl, oxazolyl, isoxazolyl, thiazolyl, thiazolinyl, isothiazolyl, thiadiazolyl, oxadiazolyl, piperidyl, piperazinyl, morpholinyl, thiomorpholinyl, tetrahydropyranyl, tetrahydrothiopyranyl, oxathiane, dioxyl, dithianyl, pyranyl, pyridyl, pyrimidinyl, pyridazinyl, pyrazinyl, triazinyl, dihydropyridyl, dihydrodithiinyl, dihydrodithionyl, homopiperazinyl, quinuclidyl, indolyl, indolinyl, isoindolyl, azaindolyl (pyrrolopyridyl), indazolyl, indolizinyl, benzotriazolyl, benzimidazolyl, benzofuranyl, benzothiophenyl, benzthiazolyl, benzoxadiazolyl, benzoxazinyl, benzodithiinyl, benzoxathiinyl, benzothiazinyl, benzoxazolyl, benzothiazolyl, benzothiadiazolyl, benzo[1,3]dioxolyl, pyrazolopyridyl, imidazopyridyl (azabenzimidazolyl), triazolopyridyl, isoxazolopyridyl, purinyl, xanthinyl, adeninyl, guaninyl, quinolinyl, isoquinolinyl, quinolizinyl, quinoxalinyl, quinazolinyl, cinnolinyl, phthalazinyl, naphthyridinyl, pteridinyl, thianaphthyl, dihydrobenzothiazinyl, dihydrobenzofuranyl, dihydroindolyl, dihydrobenzodioxinyl, tetrahydroindolyl, tetrahydroindazolyl, tetrahydrobenzimidazolyl, tetrahydrobenzotriazolyl, tetrahydropyrrolopyridyl, tetrahydropyrazolopyridyl, tetrahydroimidazopyridyl, tetrahydrotriazolopyridyl, and tetrahydroquinolinyl groups.

Heteroaryl groups are aromatic ring compounds containing 5 or more ring members, of which, one or more is a heteroatom such as, but not limited to, N, O, and S. Heteroaryl groups may be substituted or unsubstituted. Heteroaryl groups include, but are not limited to, groups such as pyrrolyl, pyrazolyl, triazolyl, tetrazolyl, oxazolyl, isoxazolyl, thiazolyl, pyridinyl, pyridazinyl, pyrimidinyl, pyrazinyl, thiophenyl, benzothiophenyl, furanyl, benzofuranyl, indolyl, azaindolyl (pyrrolopyridinyl), indazolyl, benzimidazolyl, imidazopyridinyl (azabenzimidazolyl), pyrazolopyridinyl, triazolopyridinyl, benzotriazolyl, benzoxazolyl, benzothiazolyl, benzothiadiazolyl, imidazopyridinyl, isoxazolopyridinyl, thianaphthyl, purinyl, xanthinyl, adeninyl, guaninyl, quinolinyl, isoquinolinyl, tetrahydroquinolinyl, quinoxalinyl, and quinazolinyl groups. Heteroaryl groups include fused ring compounds in which all rings are aromatic such as indolyl groups and include fused ring compounds in which only one of the rings is aromatic, such as 2,3-dihydro indolyl groups. Representative substituted heteroaryl groups may be substituted one or more times with various substituents such as those listed above.

The terms “alkyloyl” and “alkyloyloxy” as used herein can refer, respectively, to —C(O)-alkyl groups and —O—C(O)-alkyl groups. Similarly, “aryloyl” and “aryloyloxy” refer to —C(O)-aryl groups and —O—C(O)-aryl groups.

The term “carboxylate” as used herein refers to a —COOH group.

The term “ester” as used herein refers to —COOR⁷⁰. R⁷⁰ is a substituted or unsubstituted alkyl, cycloalkyl, alkenyl, alkynyl, aryl, aralkyl, heterocyclylalkyl or heterocyclyl group as defined herein.

The term “ether” as used herein refers to includes-COR¹⁰⁰ groups. R¹⁰⁰ is a substituted or unsubstituted polymer, alkyl, cycloalkyl, alkenyl, alkynyl, aryl, aralkyl, heterocyclylalkyl, or heterocyclyl group as defined herein.

The term “amide” (or “amido”) includes C- and N-amide groups, i.e., —C(O) NR⁷¹R⁷², and —NR⁷¹C (O) R⁷² groups, respectively. R⁷¹ and R⁷² are independently hydrogen, or a substituted or unsubstituted alkyl, alkenyl, alkynyl, cycloalkyl, aryl, aralkyl, heterocyclylalkyl or heterocyclyl group as defined herein. Amido groups therefore include but are not limited to carbamoyl groups (—C(O)NH₂) and formamide groups (—NHC(O)H). In some embodiments, the amide is —NR⁷¹C (O)—(C₁₋₅ alkyl) and the group is termed “carbonylamino,” and in others the amide is-NHC (O)-alkyl and the group is termed “alkanoylamino.”

The term “nitrile” or “cyano” as used herein refers to the —CN group.

Urethane groups include N- and O-urethane groups, i.e., —NR⁷³C(O)OR⁷⁴ and —OC(O)NR⁷³R⁷⁴ groups, respectively. R⁷³ and R⁷⁴ are independently a substituted or unsubstituted alkyl, alkenyl, alkynyl, cycloalkyl, aryl, aralkyl, heterocyclylalkyl, or heterocyclyl group as defined herein. R⁷³ may also be H.

The term “amine” (or “amino”) as used herein refers to —NR⁷⁵R⁷⁶ groups, wherein R⁷⁵ and R⁷⁶ are independently hydrogen, or a substituted or unsubstituted alkyl, alkenyl, alkynyl, cycloalkyl, aryl, aralkyl, heterocyclylalkyl or heterocyclyl group as defined herein. In some embodiments, the amine is alkylamino, dialkylamino, arylamino, or alkylarylamino. In other embodiments, the amine is NH₂, methylamino, dimethylamino, ethylamino, diethylamino, propylamino, isopropylamino, phenylamino, or benzylamino.

The term “sulfonamido” includes S- and N-sulfonamide groups, i.e., —SO₂NR⁷⁸R⁷⁹ and —NR⁷⁸SO₂R⁷⁹ groups, respectively. R⁷⁸ and R⁷⁹ are independently hydrogen, or a substituted or unsubstituted alkyl, alkenyl, alkynyl, cycloalkyl, aryl, aralkyl, heterocyclylalkyl, or heterocyclyl group as defined herein. Sulfonamido groups therefore include but are not limited to sulfamoyl groups (—SO₂NH₂). In some embodiments herein, the sulfonamido is —NHSO₂-alkyl and is referred to as the “alkylsulfonylamino” group.

The term “thiol” refers to —SH groups, while “sulfides” include —SR⁸⁰ groups, “sulfoxides” include —S(O) R⁸¹ groups, “sulfones” include —SO₂R⁸² groups, “sulfonyls” include —SO₂OR⁸³, and “sulfonates” include —SO₃⁻. R⁸⁰, R⁸¹, R⁸², and R⁸³ are each independently a substituted or unsubstituted alkyl, cycloalkyl, alkenyl, alkynyl, aryl aralkyl, heterocyclyl or heterocyclylalkyl group as defined herein. In some embodiments the sulfide is an alkylthio group, —S-alkyl.

The term “halogen” or “halo” as used herein refers to bromine, chlorine, fluorine, or iodine. In some embodiments, the halogen is fluorine. In other embodiments, the halogen is chlorine or bromine.

The term “hydroxyl” as used herein can refer to —OH or its ionized form, —O⁻. A “hydroxyalkyl” group is a hydroxyl-substituted alkyl group, such as HO—CH₂—.

The term “imide” refers to —C(O)NR⁹⁸C(O)R⁹⁹, wherein R⁹⁸ and R⁹⁹ are each independently hydrogen, or a substituted or unsubstituted alkyl, cycloalkyl, alkenyl, alkynyl, aryl aralkyl, heterocyclyl or heterocyclylalkyl group as defined herein.

The term “nitro” as used herein refers to an —NO₂ group.

The term “trifluoromethyl” as used herein refers to —CF₃.

The term “trifluoromethoxy” as used herein refers to —OCF₃.

The term “perfluoro” as used herein refers to a fluorinated organic compound lacking C—H bonds.

### Overview

Batteries with Li metal anodes and Si anodes show great potential as next-generation energy storage devices due to their high theoretical specific capacity (3860 Ah kg⁻¹ and 4200 Ah kg⁻¹, respectively). However, lithium metal batteries (LMB), sodium metal batteries (NMBs), and lithium-ion (“Li-ion”) batteries with Si anodes suffer from quick capacity fading. One reason for the capacity fade is the unstable interface between the anode and electrolyte. Specifically, the SEI formed from Li metal, Na metal, or Si in contact with conventional battery electrolytes are typically non-uniform and fragile. These SEIs can crack and grow further in an uncontrolled way during cycling. The heterogeneity of the SEI can be amplified with battery cycling, which may result in whisker-shaped lithium or sodium deposited on the anode and capacity fading. Applying a polymer layer to the Li anode, Na anode, or Si anode may help to stabilize this interface and promote long-term operation of LMBs, NMBs, and Li-ion batteries with Si anodes. Polymers are desirable for this application due to their solution processability, controllable mechanical properties, and tunable chemical composition. The polymer layer may have both physical and chemical interactions with the underlying Li metal, Na metal, or Si.

Disclosed herein are polymer coatings for Li metal anodes, Na metal anodes, and Si anodes that provide stable cycling and electrochemical cells incorporating these polymer coatings. The polymer coatings include a flexible backbone lending the polymer viscoelasticity. Viscoelasticity provides mechanical suppression of Li metal dendrites and Na metal dendrites and accommodates volume changes during cycling while maintaining uniform coverage on the anode during cycling. The polymers include sidechain moieties that interact with Li⁺, Na⁺, and/or the solvent used in the electrolyte to alter the Li⁻ and/or Na⁺ solvation environment. The sidechain moieties are selected so that polymer layer may modulate the transport of Li⁺ and/or Na⁺ and solvent at the interface between the anode and the electrolyte. Modulating the transport of Li⁺ and/or Na⁺ and solvent may promote the formation of a stable SEI layer, which may promote stable operation of Li, Na, and Si anodes. This polymer layer may also react with Li metal, Na metal, or Si to produce an interfacial layer.

When Li metal is in direct contact with the electrolyte, it typically reacts with both the lithium salt and the solvent in the electrolyte to form a SEI. In general, salt-derived SEIs may be more robust and promote stable long-term operation as compared to solvent-derived, organic-rich SEIs. As described herein, the polymer coating may promote salt-derived SEI formation. The polymer coating on the Li metal anode may facilitate selective transport of lithium salt and/or Li⁺ instead of solvent molecules, so that salt and/or Li⁺ may have a higher probability of being in physical contact with Li metal and promoting the formation of a salt-derived SEI. The polymer coating may incorporate salt-philic moieties, solvent-phobic moieties, or both salt-philic and solvent-phobic moieties as polymer sidechains to facilitate selective Li⁺ transport.

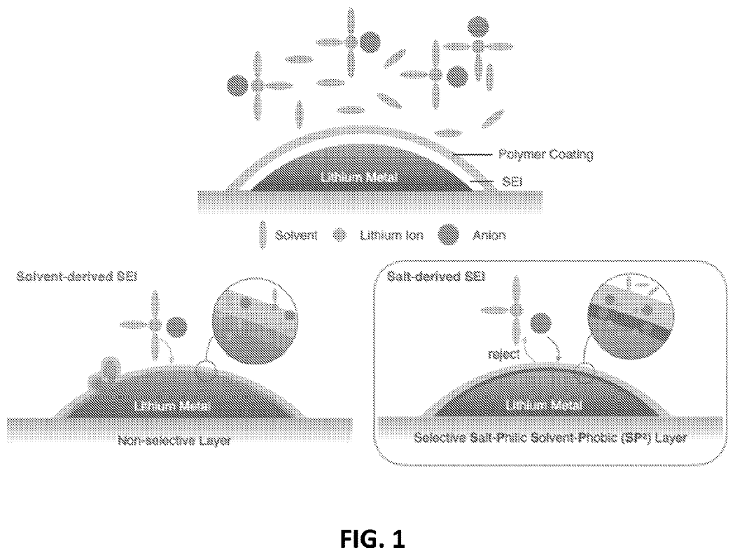

FIG. 1 is an illustration of how a salt-philic solvent-phobic (SP²) polymer coating on Li metal anode induces the formation of salt derived SEI. The polymer coating may be used in many conventional electrolyte components and has demonstrated improvement in cycling performance in battery cells using ether-based, carbonate-based, and fluorinated ether-based electrolytes. As an example, in full-cell cycling, cells with polymer-coated 50-μm thick Li anodes and 2.5 mAh cm⁻² lithium nickel manganese cobalt oxide (NMC) cathodes achieved a ˜2.5 fold increase in cycle life with 80% capacity retention using a carbonate electrolyte, and a ˜2 fold increase in a similar cell using a fluorinated ether electrolyte.

### SP² Polymer Backbone

The SP² polymers disclosed herein include a flexible polymer backbone (also called the main chain of the polymer). In any embodiment, the polymer backbone may have a structure according to any one or more of Formulas I to III:

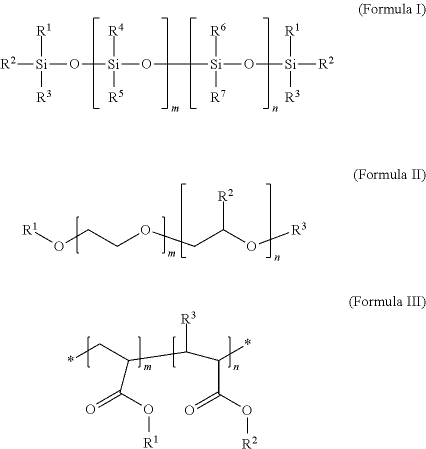

wherein:
   m is an integer between 0 and 10000, n is an integer between 0 and 10000, and m+n≥1;
   R¹ to R⁷ each independently have a structure according to Formula IV, or are C₁-C₅₀ alkyl groups or C₁-C₅₀ alkoxy groups, and at least one of R¹ to R⁷ has a structure according to Formula IV; and
   Formula IV has the structure:

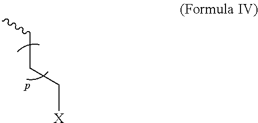

wherein p is an integer between 0 and 100, and X is a salt-philic moiety or a solvent-phobic moiety, as described in more detail below. In any embodiment, the polymer backbone may include polysiloxane, polyether, polyacrylate, or a combination of any two or more thereof.

In an embodiment, the polymer backbone is a siloxane. Siloxane-based polymers may improve the coulombic efficiencies of Li metal anodes. Beyond its chemical stability, polysiloxane chains are flexible and have a low glass transition temperature (about −150° C.). The fluid nature of the siloxane backbone offers flexibility in altering the chemical compositions of the polymer by selecting different sidechains while maintaining the viscoelastic mechanical property of the polymer. A viscous artificial SEI may prevent cracks and pinholes while maintaining uniform Li⁺ transport during cycling.

### Salt-Philic Moiety

The SP² polymers disclosed herein include a flexible polymer backbone with at least one sidechain having a salt-philic moiety or a solvent-phobic moiety. The salt-philic moiety may be a cation and/or an anion, similar to those used in ionic liquids. Polymers with salt-philic moieties have higher salt affinity, which may promote salt transport.

In any embodiment, the SP² polymer may include one or more sidechains with salt-philic cationic moieties having a chemical structure according to any of Formulas V to XVI in Table 1, wherein * indicates a point of connection to the structure according to Formula IV at X; and R¹, R², R³, and R⁴ are each independently hydrogen, fluoride, an alkyl chain, or a fluorinated alkyl chain. As an example, the salt-philic cationic moiety may be pyrrolidinium bis(trifluoromethylsulfonyl) imide (PyTFSI).

TABLE 1

| | |
|---|---|
| Formula V | 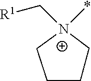 |
| Formula VI | 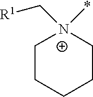 |
| Formula VII | 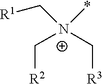 |
| Formula VIII | 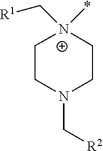 |
| Formula IX | 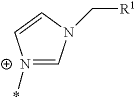 |
| Formula X | 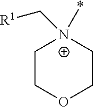 |
| Formula XI | 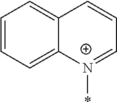 [SMILES: *[n+]1cccc2ccccc21] |
| Formula XII | 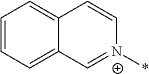 [SMILES: *[n+]1ccc2ccccc2c1] |
| Formula XIII | 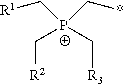 |
| Formula XIV | 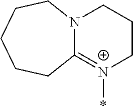 [SMILES: *[N+]1=C2CCCCCN2CCC1] |
| Formula XV | 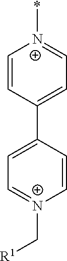 |
| Formula XVI | 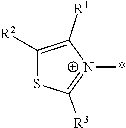 |

In any embodiment, the SP² polymer may include one or more sidechains with salt-philic anionic moieties having a chemical structure according to any of Formulas XVII to XXIII in Table 2.

TABLE 2

| | |
|---|---|
| Formula XVII | 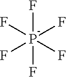 |
| Formula XVII | 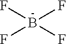 |
| Formula XVIII | 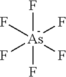 |
| Formula XIX | 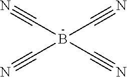 |
| Formula XX | 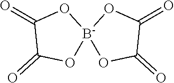 [SMILES: O=C1O[B-]2(OC1=O)OC(=O)C(=O)O2] |
| Formula XXI | 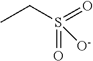 |
| Formula XXII | 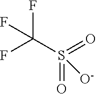 |
| Formula XXIII | 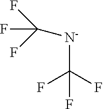 |

In any embodiment, the SP² polymer may include one or more sidechains with salt-philic anionic moieties having a chemical structure according to Formula XXIV:

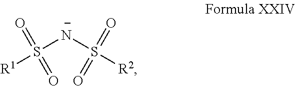

wherein R¹ and R² are independently F, a C₁-C₁₀ alkyl chain, a C₁-C₁₀ fluorinated alkyl chain, or an aryl group. For example, the SP² polymer may include any one or more of the following anionic moieties having structures according to Formulas XXV to XXXI:

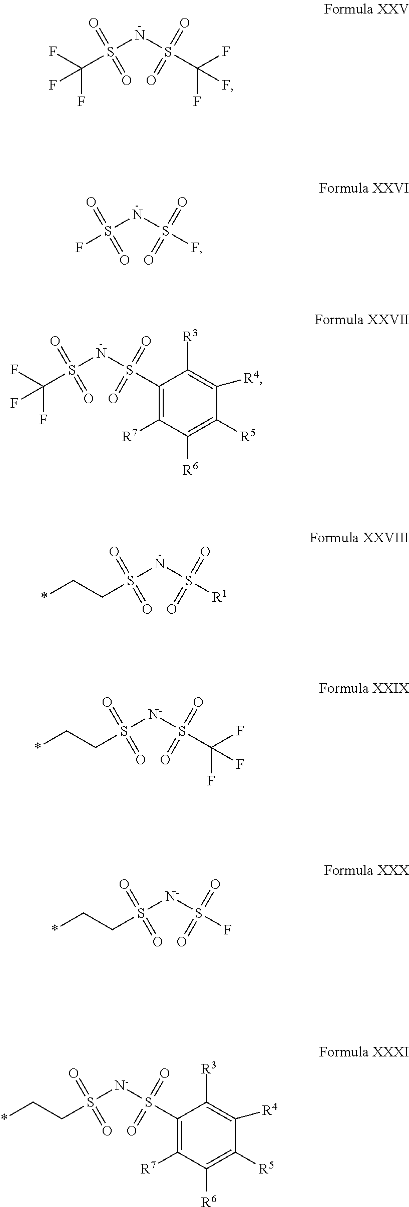

wherein * indicates a point of connection to the structure according to Formula IV at X; and R³ to R⁷ are independently F, a C₁-C₁₀ alkyl chain, or a C₁-C₁₀ fluorinated alkyl chain.

### Solvent-Phobic Moiety

The SP² polymers disclosed herein include a flexible polymer backbone with at least one sidechain having a salt-philic moiety or a solvent-phobic moiety. The solvent-phobic moiety may be immiscible with polar aprotic solvents, such as those used in conventional battery electrolytes, to substantially decrease or prevent solvent transport. As an example, the solvent-phobic moiety may include an alkyl chain, a perfluorinated alkyl chain, ether, carbonate, or a combination thereof. As another example, the solvent-phobic moiety may include 1,1,1,2,2,3,3,4,4-nonafluoro-6-propoxyhexane or hexane.

In any embodiment, the SP² polymer may include one or more sidechains with solvent-phobic moieties having a chemical structure according to Formula XXXII:

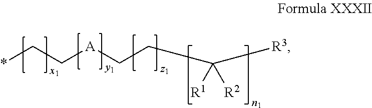

wherein R¹ to R³ are independently H, F, a C₁-C₁₀ alkyl chain, or a C₁-C₁₀ fluorinated alkyl chain;
A is O or S;
x₁ is 1 to 100;
y₁ is 0 to 100;
z₁ is 0 to 100;
n₁ is 1 to 100;
the positioning of segments x₁, y₁, z₁, and n₁ can be interchanged in any order, and
* indicates the point of connection to the sidechain according to Formula IV at point X.

For example, the solvent-phobic moiety may have a chemical structure according to any of Formula XXXIII to Formula LIV in Table 3.

TABLE 3

| | |
|---|---|
| Formula XXXIII | 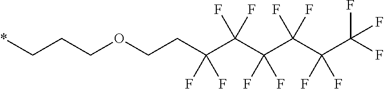 [SMILES: *CCCOCCC(F)(F)C(F)(F)C(F)(F)C(F)(F)C(F)(F)C(F)(F)F] |
| Formula XXXIV | 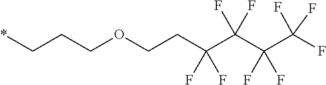 [SMILES: *CCCOCCC(F)(F)C(F)(F)C(F)(F)C(F)(F)F] |
| Formula XXXV | 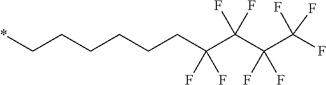 [SMILES: *CCCCCCC(F)(F)C(F)(F)C(F)(F)C(F)(F)F] |
| Formula XXXVI | 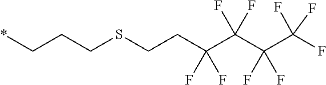 [SMILES: *CCCSCCC(F)(F)C(F)(F)C(F)(F)C(F)(F)F] |
| Formula XXXVII | 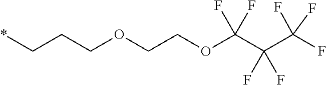 [SMILES: *CCCOCCOC(F)(F)C(F)(F)C(F)(F)F] |
| Formula XXXVIII | 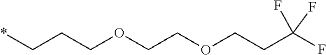 [SMILES: *CCCOCCOCCC(F)(F)F] |
| Formula XXXVIX | 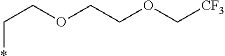 [SMILES: *CCOCCOCC(F)(F)F] |
| Formula XL | 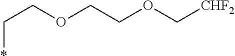 [SMILES: *CCOCCOCC(F)F] |
| Formula XLI | 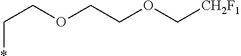 |
| Formula XLII | 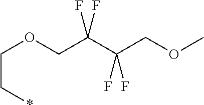 [SMILES: *CCOCC(F)(F)C(F)(F)COC] |
| Formula XLIII | 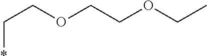 [SMILES: *CCOCCOCC] |
| Formula XLIV | 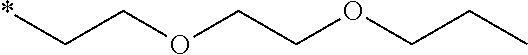 [SMILES: *CCOCCOCCC] |
| Formula XLV | 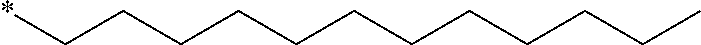 [SMILES: *CCCCCCCCCCCC] |
| Formula XLVI | 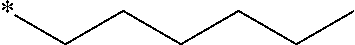 [SMILES: *CCCCCC] |
| Formula XLVII | 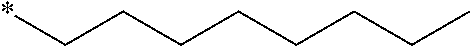 [SMILES: *CCCCCCCC] |
| Formula XLVIII | 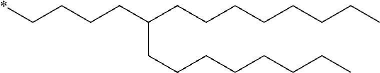 [SMILES: *CCCCC(CCCCCCCC)CCCCCCCC] |
| Formula XLIX | 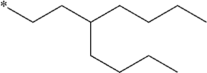 [SMILES: *CCC(CCCC)CCCC] |
| Formula L | 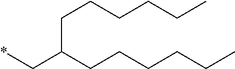 [SMILES: *CC(CCCCCC)CCCCCC] |

In any embodiment, the SP² polymer may include one or more sidechains with solvent-phobic moieties having a chemical structure according to Formula LV:

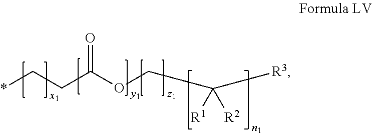

wherein R¹-R³ are independently H, F, a C₁-C₁₀ alkyl chain, or a C₁-C₁₀ fluorinated alkyl chain;
x₁ is 1 to 100;
y₁ is 0 to 100;
z₁ is 0 to 100;
n₁ is 1 to 100; and
the positioning of segments x₁, y₁, z₁, and n₁ can be interchanged in any order.

For example, the solvent-phobic moiety may have a chemical structure according to any of Formula LVI to Formula LXII in Table 4.

TABLE 4

| | |
|---|---|
| Formula LVI | 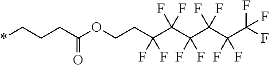 [SMILES: *CCCC(=O)OCCC(F)(F)C(F)(F)C(F)(F)C(F)(F)C(F)(F)C(F)(F)F] |
| Formula LVII | 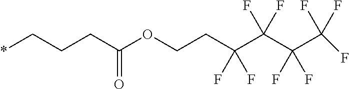 [SMILES: *CCCC(=O)OCCC(F)(F)C(F)(F)C(F)(F)C(F)(F)F] |
| Formula LVIII | 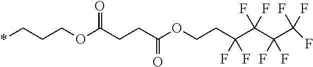 [SMILES: *CCCOC(=O)CCC(=O)OCCC(F)(F)C(F)(F)C(F)(F)C(F)(F)F] |
| Formula LIX | 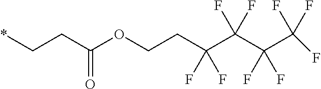 [SMILES: *CCC(=O)OCCC(F)(F)C(F)(F)C(F)(F)C(F)(F)F] |
| Formula LX | 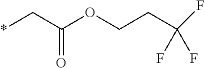 [SMILES: *CC(=O)OCCC(F)(F)F] |
| Formula LXI | 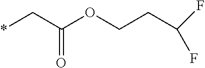 [SMILES: *CC(=O)OCCC(F)F] |
| Formula LXII | 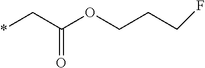 [SMILES: *CC(=O)OCCCF] |

### Physical Properties

The SP² polymer coating may have a thickness of about 0.05 μm to about 2 μm (e.g., about 0.1 μm to about 1 μm, about 0.2 μm to about 0.5 μm, or about 0.2 μm).

### Method of Deposition

The SP² polymer coating may be deposited using wet or dry processing methods. These methods are readily scalable. An example of a dry processing methods is polymer lamination.

Examples of wet deposition methods include spin coating and dip coating. The SP² polymer may be deposited via wet deposition by preparing a solution and/or suspension of the SP² polymer in a solvent (e.g., acetonitrile, 1,3trifluorobenzene, or anhydrous THF solvent). The solution may have an SP² polymer concentration of about 10 mg mL⁻¹ to about 500 mg mL⁻¹ (e.g., 50 mg mL⁻¹, 100 mg mL⁻¹, or 200 mg mL⁻¹). Substrates coated with spin coating may be spun at 200 rpm to about 5000 rpm (e.g., 500 rpm, 1000 rpm, or 2000 rpm). After coating, samples may be dried in air or in an inert environment (e.g., an Ar environment) at an elevated temperature (e.g., about 50° C. to about 100° C., or about 80° C.) to remove the solvent.

### Electrochemical Cells

In an aspect, an electrochemical cell with a Li metal anode, Na metal anode, and/or Si anode is provided. The electrochemical cell contains a non-aqueous electrolyte and is thus a non-aqueous electrochemical cell.

The non-aqueous electrolyte may include a non-aqueous solvent and a salt. The non-aqueous solvent may be a polar aprotic solvent. The polar aprotic solvent may include ether solvents, carbonate solvents, fluorinated ether solvents, or mixtures of any two or more thereof. Illustrative ether solvents include, but are not limited to, 1,3-dioxolane (“DOL”), dimethoxyethane (“DME”), methyl tert-butyl ether, dipropyl ether, glymes, or mixtures of any two or more thereof. Illustrative carbonate solvents include, but are not limited to, ethylene carbonate (“EC”), dimethylcarbonate (“DMC”), diethylcarbonate (“DEC”), propylene carbonate (“PC”), or mixtures of any two or more thereof. Illustrative fluorinated ether solvents include, but are not limited to, 2,2,3,3-tetrafluoro-1,4-dimethoxybutane (“FDMB”).

As noted, the non-aqueous electrolyte may include a non-aqueous solvent and a salt. The salt may be a salt as known for use in Li metal and/or Li-ion batteries, including lithium salts. Suitable lithium salts include, but are not limited to, lithium bis-trifluoromethanesulfonimide (LiTFSI), lithium bis(fluorosulfonyl)imide (LiFSI), LiNO₃, lithium bis (oxalato) borate (LiBOB), lithium tetrafluoroborate (LiBF₄), lithium hexafluorophosphate (LiPF₆), LiAsF₆, or mixtures of any two or more thereof. The salt may be a salt as known for use in a Na metal and/or Na-ion batteries, including sodium salts. Suitable sodium salts include, but are not limited to, sodium bis-trifluoromethanesulfonimide (NaTFSI), sodium bis(fluorosulfonyl)imide (NaFSI), NaNO₃, sodium bis (oxalato) borate (NaBOB), sodium tetrafluoroborate (NaBF₄), sodium hexafluorophosphate (NaPF₆), NaAsF₆, or mixtures of any two or more thereof.

The electrochemical cell includes a cathode including one or more cathode active materials. Illustrative cathode active materials may include, but are not limited to mixed metal oxides of lithium, nickel, manganese and cobalt with the general formula LiNiₓMn_{y}Co_{1-x-y}O₂ (“NMC”). Examples of NMC cathode active materials include LiNi_{0.33}Mn_{0.33}Co_{0.33}O₂, LiNi_{0.5}Mn_{0.3}Co_{0.2}O₂, LiNi_{0.6}Mn_{0.2}Co_{0.2}O₂, LiNi_{0.8}Mn_{0.1}Co_{0.1}O₂, or mixtures of any two or more thereof.

The electrochemical cell may also include current collectors. Current collectors for the anode and/or the cathode may include nickel, copper, stainless steel, titanium, tantalum, platinum, gold, and/or aluminum. The current collector may be a solid foil.

The electrochemical cells may also include a separator between the cathode and anode to prevent shorting of the cell. Suitable separators include those such as, but not limited to, a microporous polymer film that is nylon, cellulose, nitrocellulose, polysulfone, polyacrylonitrile, polyvinylidene fluoride, polypropylene, polyethylene, polybutene, or a blend or copolymer thereof. Commercially available separators include those such as, but not limited to, Celgard® 2025 and 3501, Tonen separators, and ceramic-coated separators.

The present invention, thus generally described, will be understood more readily by reference to the following examples, which are provided by way of illustration and are not intended to be limiting of the present invention.

### EXAMPLES

### Example 1: Depositing Polymer Coatings

To apply a layer of polymer coating on Cu or a silicon wafer, 100 mg of polymer was dissolved in 1 mL of acetonitrile or 1,3-trifluorobenzene. The polymer was spin coated on the substrate at a spin rate of 1000 rpm. The coated sample was dried in a vacuum oven at 80° C. for 24 hours to further remove organic solvents. The coating thickness was characterized by a profilometer to be around 1 μm.

To apply a layer of polymer coating on Li anodes, Li metal foil was dip coated in a suspension of 0.1 g mL⁻¹ polymer in anhydrous THF solvent. The anodes were dried in an argon environment at 80° C. for 8 hours before being assembled into a coin cell.

### Example 2: Salt Affinity and Solvent Phobicity of Polymer Coatings

In this study, four types of sidechains were selected to systematically investigate salt affinity and solvent phobicity (i.e., immiscibility) of different polymer coatings. The four types of sidechains included glyme, PyTFSI, perfluorinated alkyl chain, and alkyl chains. Glyme readily solvates lithium salt and is widely used as plasticizer for poly (ethylene oxide) solid electrolyte [24]. PyTFSI is known as an electrochemically stable ionic liquid and has good salt solvation [25,26]. Perfluorinated alkyl chains have poor solubility with lithium salt and most other organics in coating applications [10,27]. Alkyl chains similarly do not solvate salt, but are miscible with many non-polar organic solvents.

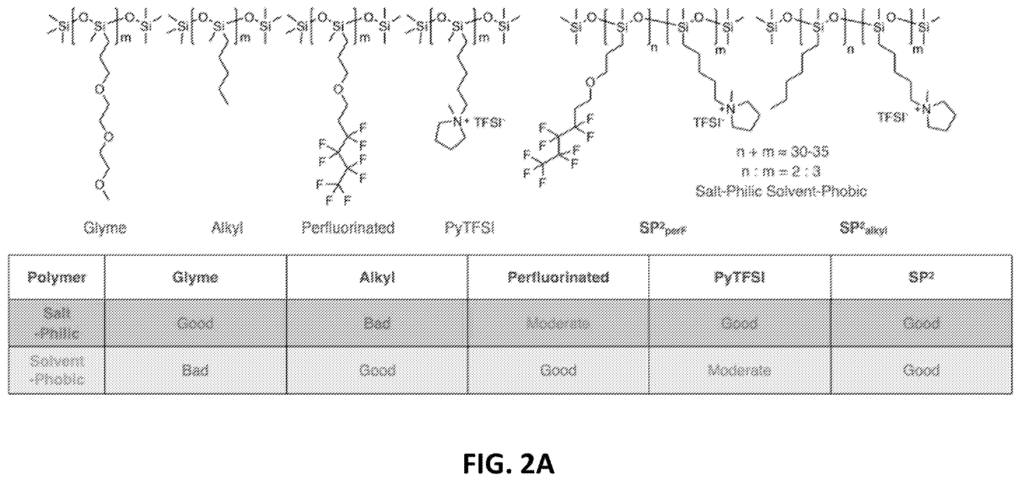

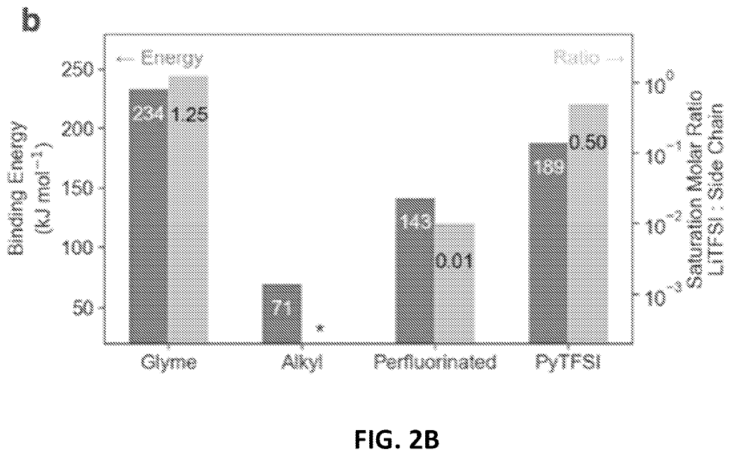

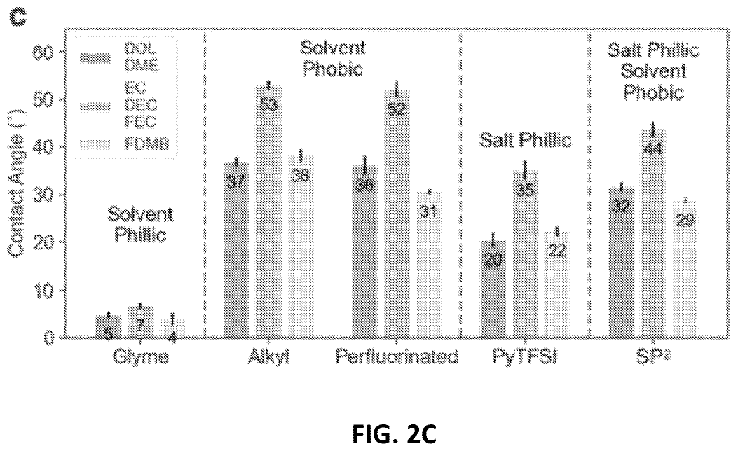

FIGS. 2A-2C characterize salt affinity and solvent phobicity of polymer coatings with the different types of sidechains. FIG. 2A shows chemical structures and a comparison of their salt/solvent interaction with different sidechains.

The salt affinities of various polymers with different sidechains were gauged by measuring the solubility of lithium bis(trifluoromethanesulfonyl)imide (LiTFSI) salt in small molecule versions of the corresponding polymer sidechains. Specifically, diglyme was selected for the glyme side chain, hexane was selected for the alkyl chain, 1,1,1,2,2,3,3,4,4-nonafluoro-6-propoxyhexane was selected for the perfluorinated alkyl chain, and PyTFSI was selected for the ionic liquid.

FIG. 2B is a graph of the polymer side chain salt affinity from DFT (density function theory) calculations. * indicates salt affinity was not detected. The molecular geometries for the ground states were calculated by DFT at the B3LYP/6-311G+(d, p) level, and then the energies of molecules were evaluated at the B3LYP/6-311G+(d, p) level. All DFT calculations were carried out with Gaussian 16 on Sherlock server at Stanford University.

As seen from the saturated molar ratio of LiTFSI to these molecules, both the diglyme and PyTFSI dissolved a large amount of LiTFSI salt (molar ratio of 1.25 and 0.5) [28,29]. In comparison, hexane exhibited poor salt solubility and no LiTFSI signal was detected in the 13C nuclear magnetic resonance (NMR) spectroscopy. The 1,1,1,2,2,3,3,4,4-nonafluoro-6-propoxyhexane solvated a small amount of LiTFSI (molar ratio 0.01, 19F NMR), showing a low level of salt-affinity. Salt affinity trends were cross validated with DFT simulations, where the interaction energy between the model side chain and LiTFSI was calculated. DFT simulations indicated the trend of salt-affinity of various sidechains agreed with the salt solvation trend: alkyl had a lower interaction energy (71 kJ mol⁻¹); glyme had a higher interaction energy (234 kJ mol⁻¹); PyTFSI had a relatively high interaction energy (189 kJ mol⁻¹).

F-NMR experiments were performed on a Varian 400 MHz NMR and the concentration of Li salt was calculated. ¹H NMR and ¹³C NMR spectra (500 MHz) were recorded on a Bruker DRX 500 NMR spectrometer in deuterated solvents at 25° C.

FIG. 2C is a graph of contact angle measurements on polymer-coated Si wafers with three types of solvents (ether; a mixture of DOL and DME; a mixture of EC, DEC, and FEC; and FDMB. The contact angle was measured by dropping 10 μL of electrolyte on coated Si wafers. Beyond salt-affinity, solvent phobicity of polymers with different sidechains was characterized through contact angle measurements. A more solvent-philic polymer may exhibit a lower contact angle. To perform this study, 10 μL of each solvent, e.g., carbonate (EC/DEC, with 10% FEC, ethylene carbonate, diethyl carbonate, fluoroethylene carbonate), ether (DOL/DME, 1,3-dioxolane, dimethoxyethane), or fluorinated ether (FDMB), was dropped onto a polymer-coated silica wafer. These solvents were selected from commonly used electrolyte formulations [31]. In addition to having high affinity to lithium salt, the glyme side chain was solvent-philic, as indicated by the low (<8°) contact angles for all three solvent types. In comparison, the polymer with salt-philic PyTFSI sidechains had higher contact angles (˜20° for ether and fluorinated ether, ˜35° for carbonate). Both the alkyl and perfluorinated sidechains showed higher levels of solvent resistance based on their higher contact angles of 30° to 40° for ether and fluorinated ether solvents and >50° for carbonate electrolyte, as shown in FIG. 2C. The solvent-phobicity of these polymers was also examined in the presence of salts. Specifically, the contact angles of electrolytes with lithium salts were measured in the same experimental set-up. The electrolytes measured with contact angle included ether (1 M LiTFSI in DOL/DME with 1 wt. % LiNO₃), carbonate (1 M lithium hexafluorophosphate (LiPF₆) in EC/DEC with 10% FEC), and fluorinated ether (1 M LiFSI, FDMB, lithium bis(fluorosulfonyl)imide). When salts were present, the contact angles of ether and fluorinated electrolytes were slightly higher (2′-5°) than the no-salt experiments. However, the presence of salt did not change the overall observed correlation between polymer chemistry and solvent-affinity.

The above experiments indicated that the PyTFSI side chain is salt-philic with moderate solvent-phobicity. To further increase the solvent-phobicity of the polymer, 40% of the PyTFSI sidechains were replaced with perfluorinated alkyl chains (which are solvent-phobic with moderate salt-affinity) and/or alkyl chains (which are solvent-phobic with low salt-affinity). These combinations of sidechains increased solvent contact angle from 20° to 32° in ether, from 35° to 44° in carbonate, and from 22° to 29° in fluorinated ether solvents, as shown in FIG. 2C. The polymer with PyTFSI sidechains and perfluorinated alkyl chains and/or alkyl chains was termed “SP²_{perF}” and “SP²_{alkyl},” respectively, where SP² refers to salt-philic and solvent-phobic properties. This polymer coating may selectively transport salt over solvent.

### Example 3: Selective Transport of Polymer Coatings

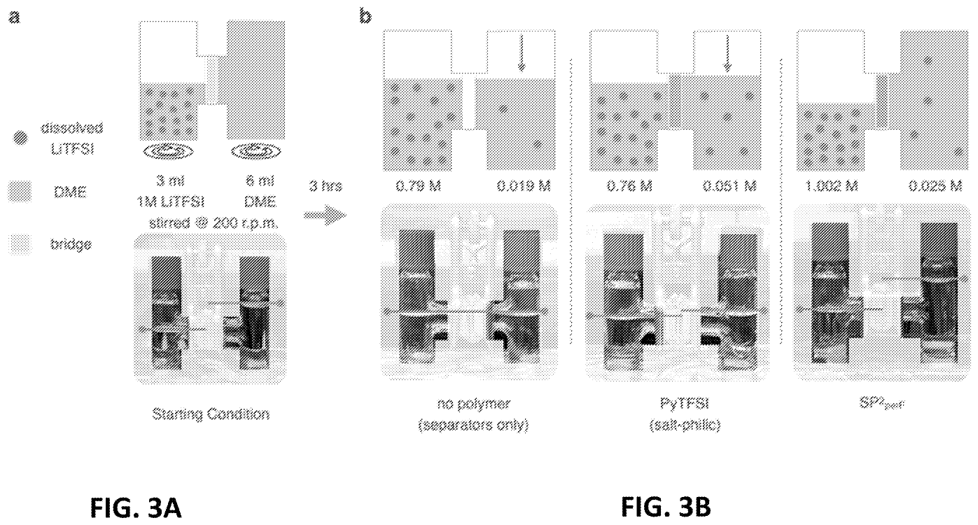

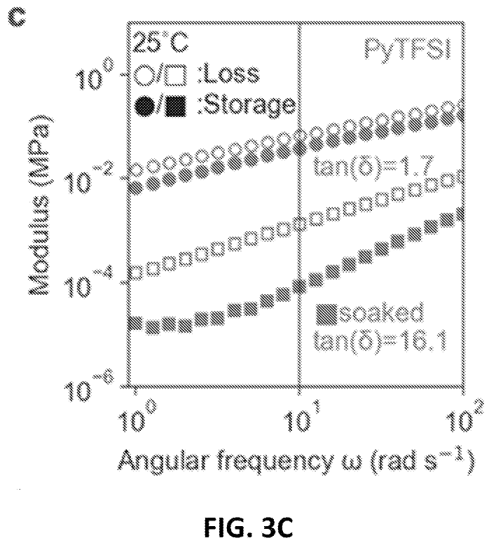

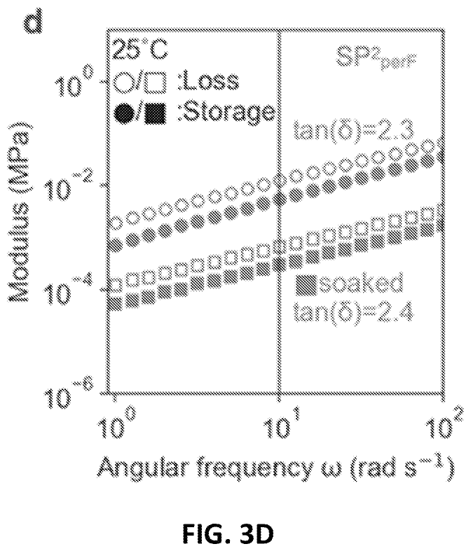

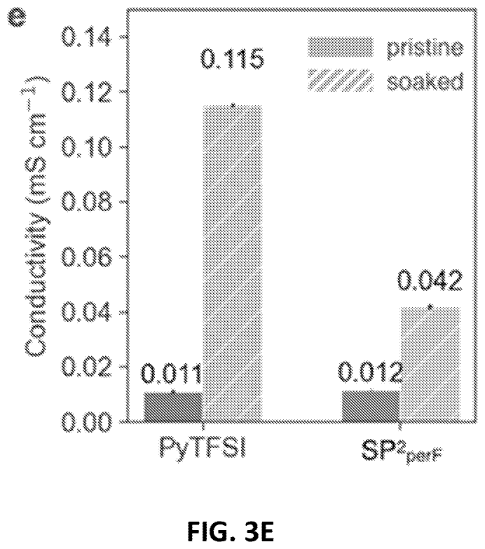

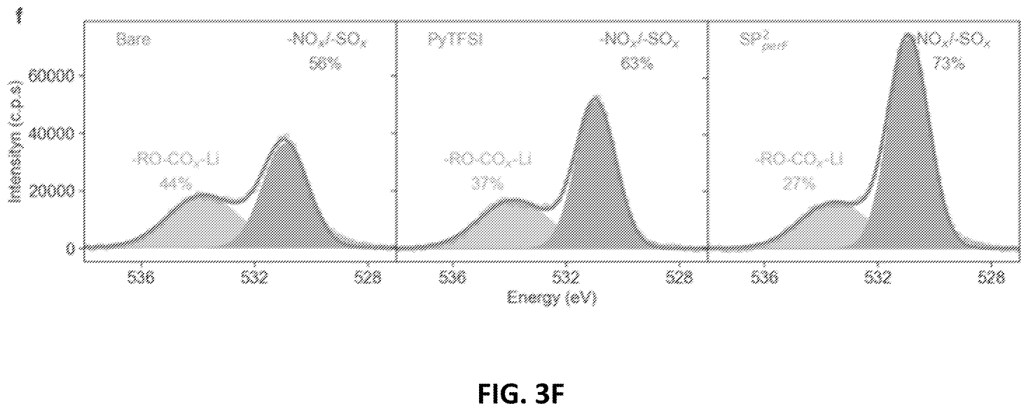

FIGS. 3A-3F characterize selectivity of pyrrolidinium bis(trifluoromethylsulfonyl)imide (PyTFSI) and an SP² polymer with PyTFSI sidechains and perfluorinated sidechains (SP²_{perF}). FIG. 3A illustrates the experimental set-up for H-cell experiments. To characterize the selective transport of the SP² polymer, an H-cell experiment was designed using each polymer as the bridge. The LHS (left-hand side) of the H-cell was initially filled with 3 mL of 1 M LiTFSI DME electrolyte, and the RHS (right-hand side) was filled with 6 mL DME solvent. The two sides were separated by two layers of separators with 100 mg of polymer sandwiched between the layers of separators. As the system equilibrates, the concentration difference drives the diffusion of salt from the LHS to the RHS and solvent from the RHS to the LHS. To avoid vacuum build-up upon solvent flow, the caps of the H-cell were loosened.

The H-cell experiment was performed in an Ar environment (glovebox) at room temperature with both sides of the H-cell under constant stirring (200 rpm). The caps of the H-cell were left loose. 100 mg of polymer was sandwiched between two layers of separators. The experiment was run for 3 hours before stopping and a picture of the liquid level was taken. Afterwards, 1 mL of the liquids from both sides was harvested and 100 μL of 1,1,2,2-tetrafluoroethyl-2,2,3,3-tetrafluoropropyl ether (TTE) was added into the solution as an internal concentration standard.

FIG. 3B illustrates the H-cell experimental results with the blue dots representing the LiTFSI salt concentration and salt concentration values listed below. FIG. 3B includes cartoon and digital images of the H-cell results. Visually, the lowering of the liquid line on the RHS is an indication of DME diffusion from right to left. The salt concentration was evaluated with 19F NMR, using a standard electrolyte, as noted in FIG. 3B. When there was no polymer present, the liquid levels of the two sides were equal after about 3 hours, indicating significant DME diffusion from right to left, and salt transport from the LHS to the RHS, resulting in the salt concentration on the RHS reaching 0.019M. When the H-cell included a polymer with PyTFSI sidechains, the liquid level on the RHS almost matched that of the LHS, indicating significant solvent migration. Since PyTFSI is salt-philic, there may be increased LiTFSI transport compared to the H-cell without a polymer. The H-cell with the polymer with PyTFSI sidechains had a final RHS concentration of 0.051M. The H-cell with the SP²_{perF} polymer had a liquid level difference that was maintained even after 3 hours and the LHS salt concentration rose from zero to 0.025 M, demonstrating selective transport of salt over solvent. The LiTFSI concentration remained at 1 M on the LHS, instead of lowering, which may be attributed to the slight evaporation of DME compensating for the salt diffusion. SP²_{perF} polymer also showed selective transport at higher salt concentration (starting condition: LHS, 3 mL 4M LiTFSI DME, RHS, 6 mL DME). At higher salt concentration, no appreciable solvent diffusion across the SP²_{perF} polymer was observed, while the LHS reached 0.07 M of LiTFSI after 3 hours.

To understand if the integrated SP²_{perF} polymer coating design may be applied to other polymer sidechains, SP²_{alkyl} polymer was also synthesized, replacing the perfluorinated chain with the alkyl chain while maintaining the side chain ratio. Both perfluorinated and alkyl chains were solvent-phobic, as shown in FIG. 2B, but the polymer with the perfluorinated chain showed a higher salt-affinity, as shown in FIG. 2C. The SP²_{alkyl} polymer was used in an H-cell with 1 M LiTFSI starting condition (same as above). Similar to SP²_{perf}, selective transport of salt-over-solvent was observed. However, the concentration of LiTFSI on the LHS after 3 hours was 0.01M, lower than that of SP²_{perF}. This difference may be attributed to differences in salt-affinity of SP²_{alkyl} as compared to SP²_{perF}.

### Example 4: Mechanical Property and Ionic Conductivity of Polymer Coatings

FIG. 3C is a graph of rheological frequency sweep of a polymer with PyTFSI sidechains before (circle) and after (square) being soaked in DME solvent for 8 hours, with the tan (delta) at 10 rad s⁻¹ marked. The rheological measurements were conducted on a TA ARES G2 rheometer with an 8 mm parallel plate geometry. FIG. 3D is a graph of rheological frequency sweep of SP²_{perF} polymer before (circle) and after (square) being soaked in DME solvent for 8 hours, with the tan (delta) at 10 rad s⁻¹ marked. The presence of a solvent-phobic side chain was also expected to limit the swelling of the polymer in solvents. Specifically, the mechanical properties and ionic conductivities of polymers before and after soaking in DME were compared. FIG. 3C shows polymer with PyTFSI sidechains and FIG. 3D shows SP²_{perF} polymer. The frequency dependent modulus of the polymer in rheological measurements was characterized. The loss modulus (G″) represented the liquid characteristic and the storage modulus (G′) represented the solid characteristic. Before soaking, both the SP²_{perF} and the PyTFSI polymers showed viscous behavior with G″ higher than G′ in the characterized frequency range. After swelling, the polymer showed a decrease in both storage and loss moduli, indicating reduction in mechanical strength. Specifically, the relative liquid to solid characteristic of the polymer was characterized by calculating the tan (8) (ratio between G″ and G′) at the angular frequency of 10 rad s⁻¹. For the PyTFSI polymer, the tan (8) increased close to an order of magnitude (1.7 to 16) upon soaking, while the SP²_{perF} polymer's tan (8) remained relatively constant (2.3 to 2.4). After swelling, the PyTFSI polymer became more liquid-like, indicating that it was less resistive to solvent swelling.

FIG. 3E is a graph of ionic conductivity at 25° C. of polymer with PyTFSI sidechains and SP²_{perF} polymer before and after being soaked in DME solvent for 8 hours. The ionic conductivities of the polymers were measured before and after soaking with electrochemical impedance spectroscopy (EIS) at 25° C. The ionic conductivity was measured with a biologic VMP3 system at room temperature in a SS|SS (stainless steel) coin cell geometry. The ionic conductivity was attributed to ionic dissociation of the PyTFSI moieties. After soaking the polymer in the electrolyte, the conductivity of PyTFSI increased by an order of magnitude (0.011 mS cm⁻¹ to 0.115 mS cm⁻¹), while the conductivity of SP²_{perF} polymer did not increase as much (0.013 mS cm⁻¹ to 0.042 mS cm⁻¹). This result is consistent with a higher solvent resistance of the SP²_{perF} polymer as compared to the polymer with only PyTFSI moieties. Based on both the mechanical characterization and ionic conductivity measurements, the addition of solvent-phobic side chain may reduce solvent uptake.

### Example 5: Characterization of SEI Layers in Li|Cu and Li|Li Cells

The effects of salt vs. solvent polymer interaction and reactivity on cycling was examined. Specifically, the stability of Li SP²_{perF} polymer's ability to affect SEI formation was examined. Li|Cu cells were assembled with polymer-coated Cu current collectors. Li was stripped and plated through the polymer layer, which had an initial thickness of about 100 nm. The Li|Cu cells used a 1 M LiTFSI DOL/DME 1 wt % LiNO₃ electrolyte and were cycled for 10 cycles to produce a layer of SEI underneath the polymer coating. SEM images of the SEI indicated the SEI on uncoated Cu was about 17.80 μm, with irregular granular structures. The SEI on SP²_{perF} coated Cu was thinner (about 12.86 μm) and initially covered with the SP²_{perF} polymer. The SP²_{perF} polymer was removed with tetrahydrofuran (THF), revealing a uniform and compact SEI deposited on the Cu.

The SEI chemistry was characterized with X-ray photoelectron spectroscopy (XPS). FIG. 3F shows X-ray photoelectron spectroscopy (XPS) graphs of oxygen O1s peaks of SEI layers formed on Li anodes (from left to right: bare, coated with polymer with PyTFSI sidechains, and coated SP²_{perF} polymer, respectively) with signals attributed to either salt or solvent decomposition and their relative percentage values noted. The XPS samples were not washed with solvents to preserve the original SEI chemistry. The O1s spectra of the cycled Cu electrode after 2 min of sputtering were shown in FIG. 3F. When the Cu surface was not sputtered, a large amount of C and Si signals was observed. After 1 min of sputtering, the C signal was reduced, and the Si signal was no longer recognizable, which indicated that the polymer layer was removed. Further sputtering did not change the observed spectrum, indicating that the SEI composition was not influenced by the sputtering process. The peak at 530.9 eV was attributed to —NOₓ/SOₓ, attributed to decomposition of LiTFSI salt, and the peak at 533.8 eV was attributed to —RO—COₓ—Li, attributed to solvent decomposition. By calculating the percentage of the peak area attributed to salt/solvent breakdown, the polymer coating's ability to form salt-derived SEI was quantified. When there was no coating, 56% of the SEI was attributed to salt decomposition. When the PyTFSI polymer coating was present, the salt-derived SEI content increased to 63%. This content may be further improved to 73% when SP²_{perF} polymer coating was used. Due to the selective transporting ability of the SP²_{perF} polymer, the deposited Li may have limited access to solvent molecules, resulting in salt-derived SEI and a uniform morphology [32].

The XPS profile was collected on a PHI VersaProbe 3 XPS with an Al K-alpha source, and the sample was transferred from the Ar glove box to the testing stage in an airtight vessel. The O1s XPS was collected after the sample surface was sputtered with Ar at 2 kV μA for 2 min.

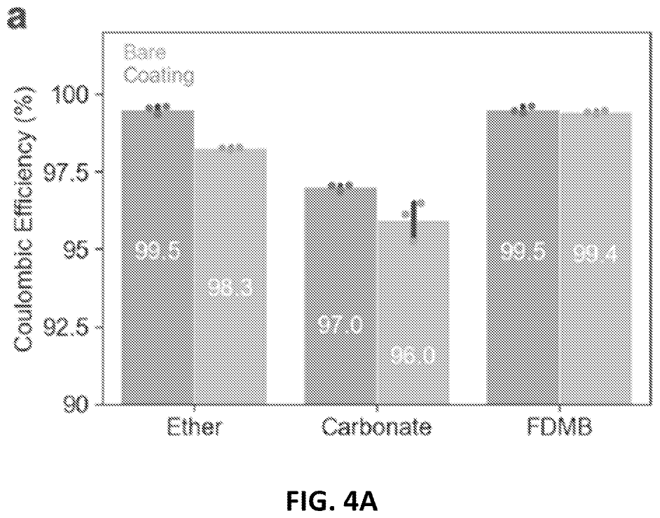

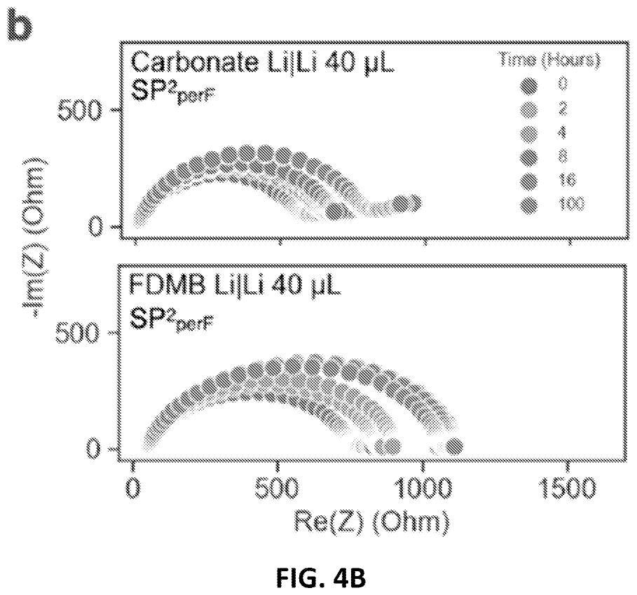

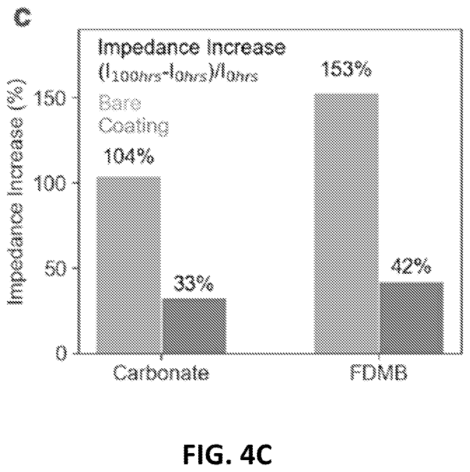

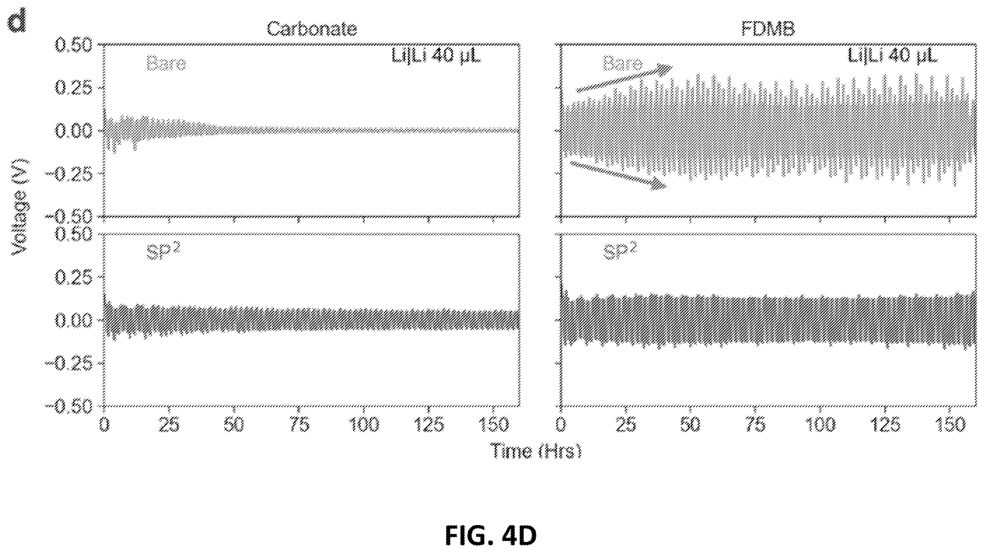

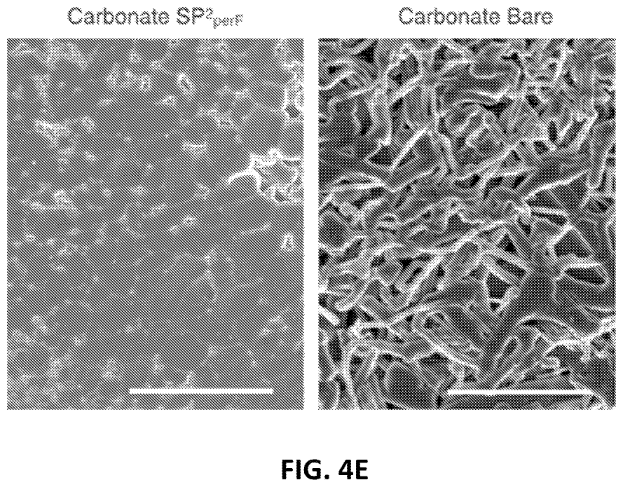

FIGS. 4A-4E show electrochemical characterization of SP²_{perF} with different electrolytes. The ability of SP²_{perF} polymer to tune SEI to desirable composition may lead to marked improvements in electrochemical performance in Li|Cu cycling. FIG. 4A is a graph of coulombic efficiency (C.E.) of SP²_{perF} polymer-coated Cu in Li|Cu cells with 40 μL of ether-based electrolyte (1 M LiTFSI in DOL/DME with 1 wt. % LiNO₃), carbonate-based electrolyte (1 M LiPF₆ in EC/DEC with 10% FEC), and FDMB-based electrolyte (1 M LiFSI in FDMB). As shown in FIG. 4A, the coulombic efficiency (C.E.) was compared for two conditions: with and without a SP²_{perF} polymer coating. Cells were cycled under a short-term 10 cycles at 0.5 mA cm⁻¹ and 1 mAh cm⁻¹ cycling protocol [33]. In 1 M LiTFSI DOL/DME 1 wt. % LiNO3 electrolyte, the C.E. increased from 98.3% to 99.5% with a SP²_{perF} polymer coating. The C.E. was also examined in carbonate (1M LiPF₆ EC/DEC with 10% FEC), as well as 1 M LiFSI in FDMB electrolyte. In carbonate electrolyte, the C.E. increased from 96.0% to 97.0%. In FDMB electrolyte, since this electrolyte achieves higher C.E. in this short-term cycling protocol, only a small increase in C.E. was observed with the addition of the SP²_{perF} coating (99.4% to 99.5%).

FIG. 4B shows graphs of time-dependent electrochemical impedance spectroscopy (EIS) measurements with SP²_{perF} coated Li|Li symmetric cells in either carbonate-based (top) or FDMB-based (bottom) electrolytes. FIG. 4C is a graph of impedance increase (%) over 100 hours calculated from the EIS measurements in FIG. 4B. FIG. 4D shows graphs of voltage curves of Li|Li symmetric cells with or without SP²_{perF} coatings in carbonate-based (left) or FDMB-based (right) electrolytes. FIG. 4E show scanning electron microscopy (SEM) top view images of Li deposited on SP²_{perF} polymer-coated Cu (left) and bare Cu (right) electrodes in carbonate-based electrolyte, with a scale bar of 10 μm.

FIG. 4B showed the individually plotted voltage profile of one set of cells for the C.E measurements in FIG. 4A. The SP² polymer coating was paired with 1.2 M LiFSI in 2-(2-(2,2-difluoroethoxy) ethoxy)-1,1,1-trifluoroethane (F5DEE) and the C.E. increased from 99.5% to 99.6%. There is less room for C.E. improvement when the baseline C.E. is already high. However, in long-term tests, small increasements of C.E. may still translate to longer cell cycle life.

As discussed above, the SP²_{alkyl} polymer has a lower salt-affinity compared to SP²_{perF}, but still showed selective transport of salt over solvent. To examine SP²_{alkyl}'s battery performance, SP²_{alkyl} coated Li|Cu cells were cycled with the short-term cycling protocol. For Li|Cu cells with carbonate-based electrolyte, the SP²_{alkyl} polymer coating improved performance (C.E. increased from 96.0% to 96.6%). However, Li|Cu cells with FDMB-based electrolyte demonstrated a C.E. decrease from 99.4% to 98.9%. The SP²_{alkyl} coated electrode had higher overpotential (0.0496V) than the SP²_{perF} coated electrode (0.0405V), and the standard deviation was doubled. Due to the lower salt-affinity of SP²_{alkyl}, the ion transport at the electrode interface may be impeded. Especially in electrolytes with limited ionic conductivity, the large deposition overpotential may drive undesirable degradation (low C.E.) and reduced operational stability, leading to a high standard deviation. [34,36] Overall, polymer coatings with both solvent-phobicity and salt-affinity such as SP²_{perF} showed more stable cycling performance.

The way SP²_{perF} coatings affect EC/DEC and FDMB electrolytes' stability with Li metal anodes was characterized through EIS and long-term cycling in Li|Li symmetric cells. FIG. 4B shows the interfacial impedance of SP²_{perF} coated Li in carbonate or FDMB electrolyte for different lengths of time. Li|Li symmetric cells without coatings were used as comparison. For both electrolytes, the SP²_{perF} polymer coating was observed to suppress increases in interfacial impedance over time. The interfacial impedance increase was quantified with the formula: (I_{100 hrs}−I_{0 hrs})/I_{0 hrs} (%). For the first 100 hours (hrs.), the cell with the SP²_{perF} polymer coating exhibited an impedance increase from 104% to 33% in carbonate electrolyte, and from 153% to 42% in FDMB electrolyte, as shown in FIG. 4C. Since the SP²_{perF} polymer was coated on the Li surface with THE as solvent, THF's influence on interfacial impedance was also examined. Bare Li metal was treated with THF and its impedance evolution was tracked in carbonate electrolyte. With or without THE treatment, Li electrodes experienced similar impedance increase of about 100%, indicating that the SP² polymer may be responsible for the reduced impedance increase.

Li|Li symmetric cells were also cycled at a 1 mAh cm⁻¹ current density and 1 mAh cm 1 capacity, as shown in FIG. 4D. The cell with the carbonate electrolyte had a higher deposition overpotential with the addition of the SP²_{perF} coating. The higher overpotential was stable over many cycles. The cell with the uncoated Li anode exhibited an overpotential decrease between 25 and 40 cycles. This decrease may be due to increased Li surface area resulting from irregular whisker-shaped lithium deposition [35]. SEM images indicated the formation of these irregular depositions, as shown in FIG. 4E. SEM images also indicated that the addition of the SP²_{perF} polymer coating on Li promoted homogeneous deposition instead of whisker-shaped deposition. For the cells with FDMB electrolyte, the SP²_{perF} polymer coating maintained a stable overpotential over time. Without the SP²_{perF} coating, the cells with FDMB electrolyte continued to experience lithium metal reaction with electrolyte, increasing the deposition overpotential. [30] In both electrolytes, the SP²_{perF} polymer coating limited solvent breakdown at the Li electrode and sustained stable operation.

To further understand the range of solvent-phobicity and salt-affinity of different coatings deposited at the interface, Li|Cu cells were assembled with a solvent-philic polymer coating, a polymer with a siloxane backbone and glyme sidechains (“siloxane-glyme”). In carbonate electrolyte, this coating demonstrated limited improvement in C.E. (96.0% to 96.1%). The lithium deposition morphology remained whisker-shaped with or without the coating, as measured with SEM. This finding indicates the effect of polymer coatings with solvent-phobicity at the electrode-electrolyte interface.

Li|Cu cells were assembled with thick Li chip (1 cm²) and polymer coated Cu electrodes with 40 μL of electrolyte (unless otherwise specified) and Celgard 2325 separators. For C.E. measurement, the electrode surface was first cleaned by 10 cycles of charge and discharge at 0.02 mA cm⁻² between 0 V and 1 V. Then, 5 mAh cm⁻² was deposited at 0.5 mA cm⁻², followed by 10 cycles of stripping and plating at the same current density and 1 mAh cm⁻² capacity, and finally completely stripping the deposited lithium from the copper electrode. The XPS signal was collected on the Cu electrode cycled at 0.5 mA cm⁻² current density and 1 mAh cm⁻² capacity for 10 cycles. For the SEM images, Li was plated and stripped at a current density of 0.5 mA cm⁻¹ for 5 cycles before plating 1 mAh of Li at the same current density. Prior to the SEM image, each sample was quickly dipped in 1,3-trifluorobenzene to remove the polymer coating and excess salt and solvent molecules. Li electrodes were dip coated with 0.1 g/mL SP² polymer suspended in anhydrous tetrahydrofuran (THF) solvent. The electrode was dried in the Ar environment at 80° C. for 8 hours before being assembled into a coin cell. All cells were rested for 8 hours prior to cycling.

### Example 6: Li|NMC Cell Cycling

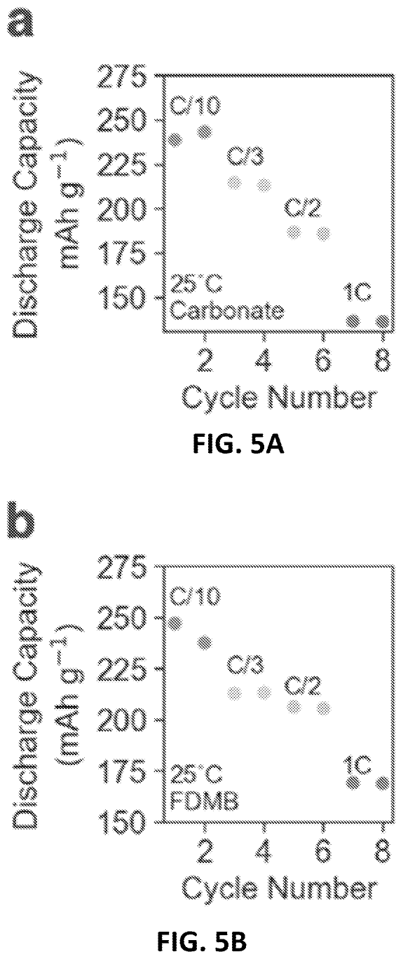

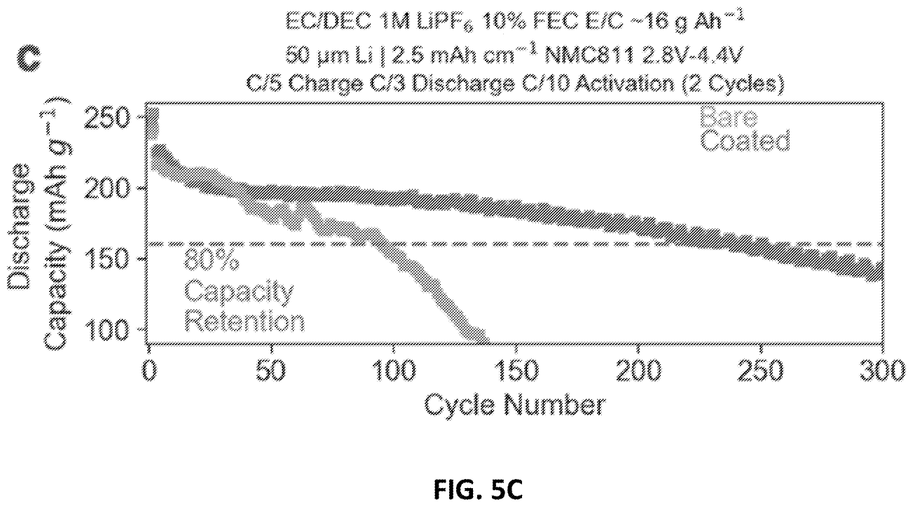

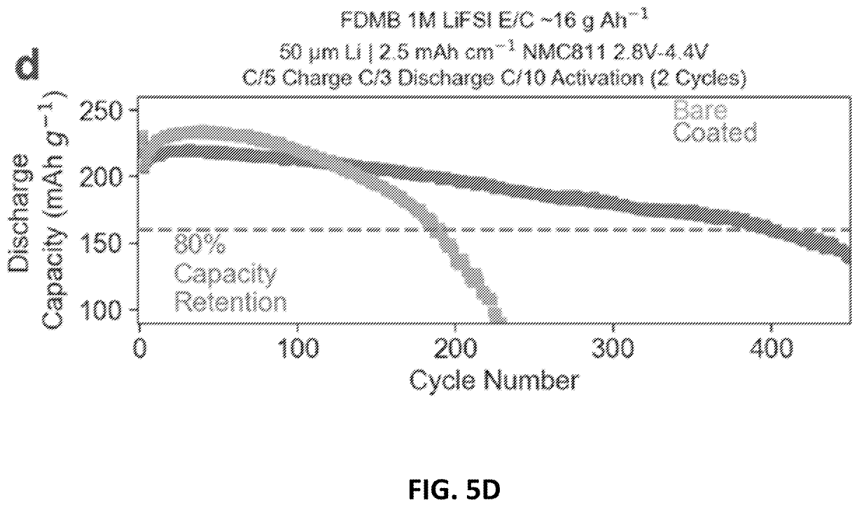

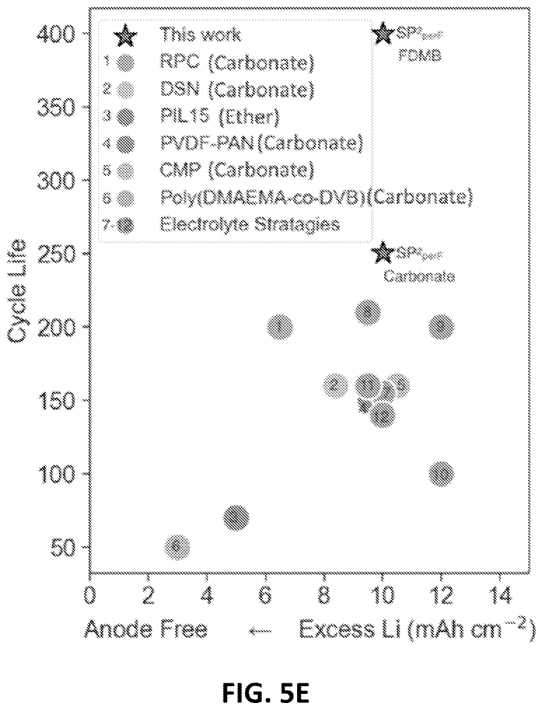

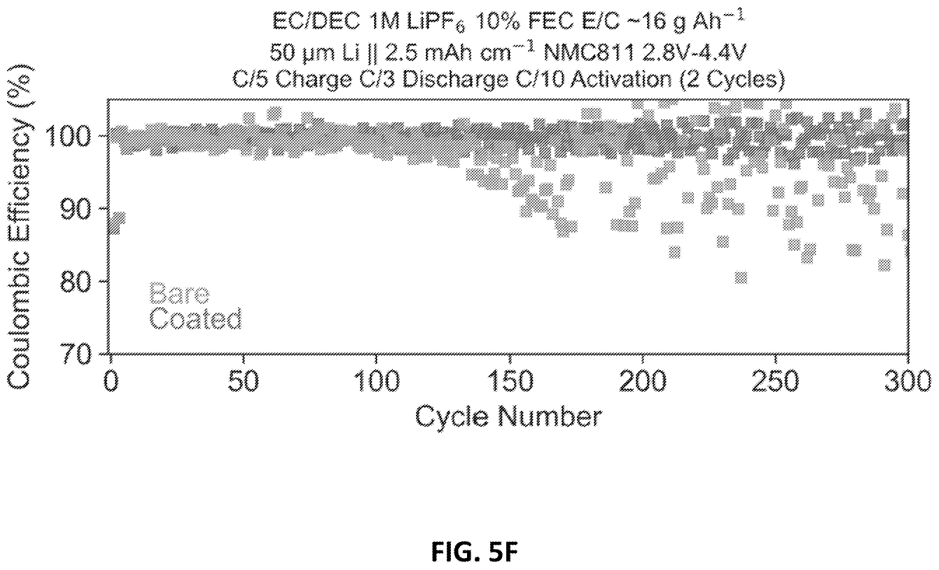

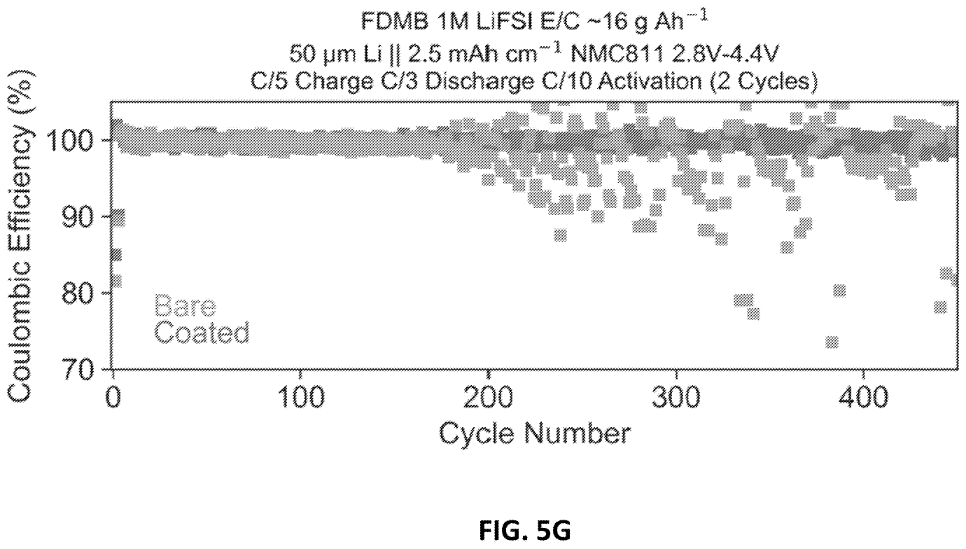

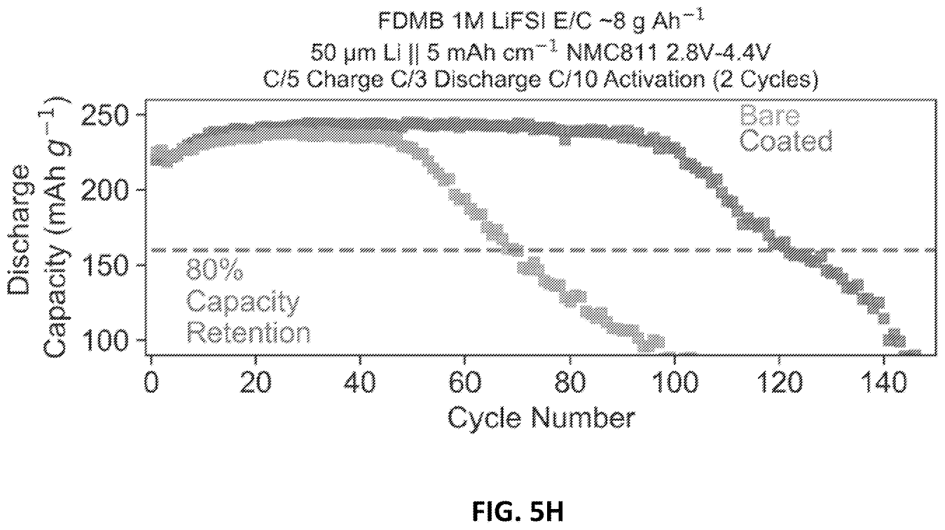

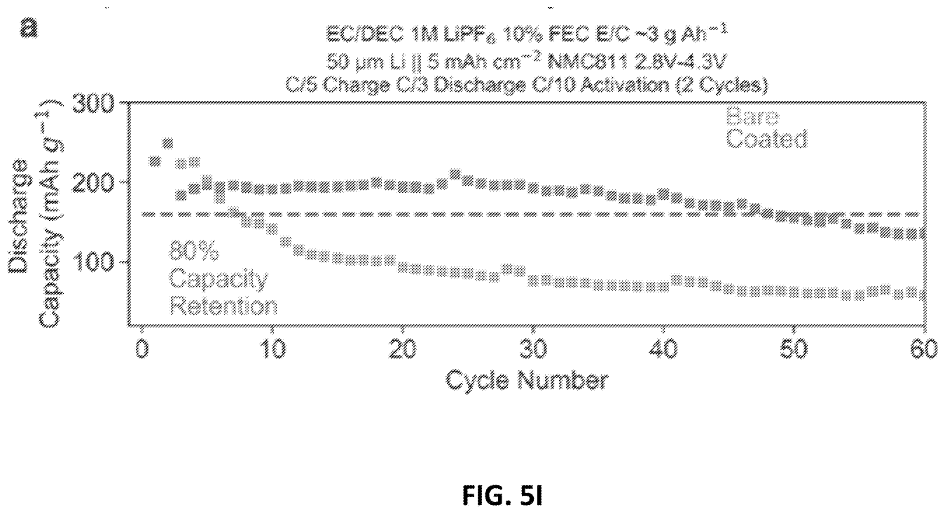

FIGS. 5A-5I show cycling of SP²_{perF}-coated Li anodes in Li|NMC cells. FIG. 5A is a graph of rate capability with carbonate-based electrolyte. FIG. 5B is a graph of rate capability with FDMB-based electrolyte. FIG. 5C is a graph of long-term cycling with carbonate-based electrolyte. FIG. 5D is a graph of long-term cycling with FDMB-based electrolyte. FIG. 5E is a comparison of cycle life (80% capacity retention) plotted against accessible lithium amount of the SP²_{perF} coating with other coatings and electrolytes, where the x-axis locations of 4, 5, 7, 11, and 12 are at 10 mAh cm⁻², and they are adjusted slightly to dodge. FIG. 5F is a graph of Coulombic efficiency (C.E.) of Li|NMC cells with coated or bare Li anodes in carbonate-based electrolyte. FIG. 5G is a graph of Coulombic efficiency (C.E.) of Li|NMC cells with coated or bare Li anodes in FDMB-based electrolyte. FIG. 5I is a graph of discharge capacity of Li|NMC cells with coated or bare Li anodes cycled in carbonate-based electrolyte.

Since the SP² coatings showed improvement in both carbonate and FDMB electrolyte, SP²_{perF} coated thin Li anodes (50 μm) were assembled into Li|NMC cells. The cells were cycled at different C-rates, and a reasonable capacity (>200 mAh g⁻¹) was achieved at C/10 and C/3 for both carbonate and FDMB electrolytes, as shown in FIGS. 5A and 5B. Cells were also cycled at C/5 charging and C/3 discharging in long-term cycling. FIGS. 5C and 5D show the discharge capacity over 300 cycles when paired with NMC cathodes with 2.5 mAh cm⁻² in either carbonate or FDMB electrolytes, respectively. FIGS. 5F and 5G show C.E. for the cycling shown in FIGS. 5C and 5D. For cells using carbonate electrolyte, a cycle life of about 250 cycles was reached, and for cells using FDMB electrolyte, a cycle life of about 400 cycles was reached.

FIG. 5H shows cycling of Li|NMC cells with higher (5 mAh cm⁻²) cathode capacity in FDMB electrolyte. The addition of the SP²_{perF} coating on the Li anode marked about a twofold increase in the cell cycle life.

The SP²_{perF} coating was applicable to various electrolyte chemistries and demonstrated a marked improvement in cell cycle life and capacity when compared with other Li anode modification strategies, as shown in FIG. 5E. [11, 14, 43, 44, 16, 26, 37-42.]

FIG. 5I is a graph of discharge capacity of Li|NMC cells with coated or bare Li anodes cycled in carbonate-based electrolyte. A Li|NMC cell with a SP perF coating on the Li anode was cycled under lean electrolyte conditions of about 15 μL of carbonate-based electrolyte (as compared to 40 μL used in other experiments) with a cathode loading of about 3 g Ah⁻¹ and compared to a cell without the coating. Results indicated that the SP²_{perF} coating improved the cycling stability by about two- to fourfold in the carbonate electrolyte.

The chemistry of SEI can influence the stability of lithium metal batteries. In this work, a polymer coating with salt-philic and solvent-phobic sidechain moieties was deposited on the Li anode. The polymer coating promoted the formation of a salt-derived SEI and prolonged battery cycling. The sidechains of the polymer coating may be chosen to systematically tune the SEI to achieve desirable composition. Material and electrochemical characterizations showed that both solvent phobicity and salt affinity influence the formation of a more stable SEI. The polymer coating composition may improve battery performance in different types of electrolyte, including those that are ether-based, carbonate-based, and fluorinated ether-based. This polymer coating was applied to thin-Li|NMC full cells and demonstrated improved battery cycling performance with different electrolytes.

### Example 7: Polymer Synthesis

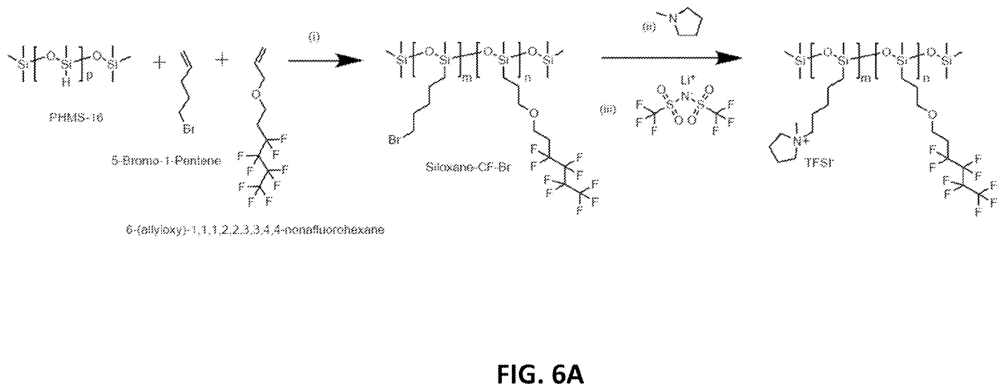

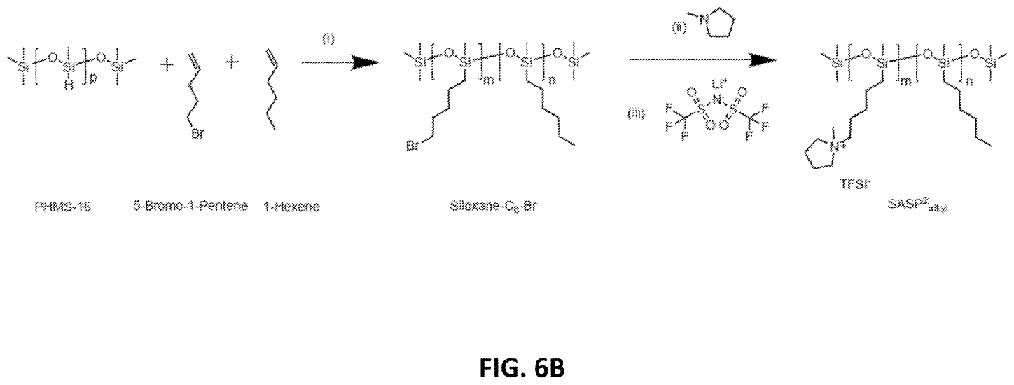

Synthesis of Siloxane-CF—Br. FIG. 6A shows the reaction scheme for the synthesis of siloxane-CF—Br in step (i). Siloxane-CF—Br has the chemical structure:

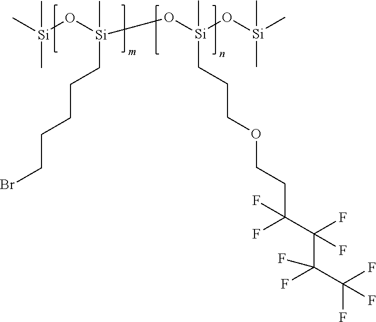

Siloxane-CF—Br was synthesized by the addition reaction between polymethylhydrosiloxane (“PHMS”) and 5-bromo-1-pentene and 6-(allyloxy)-1,1,1,2,2,3,3,4,4-nonafluorohexane. PHMS (2 g, 30 mmol), 5-bromo-1-pentene (2.96 g, 20 mmol) and 6-(allyloxy)-1,1,1,2,2,3,3,4,4-nonafluorohexane (3.8 g, 12.5 mmol) were charged in a 250 mL three-necked flask equipped with a reflux condenser and a magnetic stirrer. Toluene (100 mL) was added, and the mixture was stirred to dissolve the reactant. Then, Karstedt catalyst solution (100 μL, 2% Pt in p-xylene) was added via a syringe, and the mixture was heated at 85° C. for 48 h. After the reaction, toluene and the remaining 5-Bromo-1-Pentene were removed under vacuum, and the siloxane-CF—Br was obtained as a viscous light-gray liquid. Yield: 8.32 g (94.9%). ¹H NMR (500 MHz, CDCl3, δ) showed the ratio of m and n was about 6:4.

Synthesis of SP²_{PerF}. Steps (ii) and (iii) in FIG. 6A show the reaction scheme for the synthesis the polymer SP²_{PerF} from siloxane-CF—Br. The polymer SP²_{PerF} has the chemical structure:

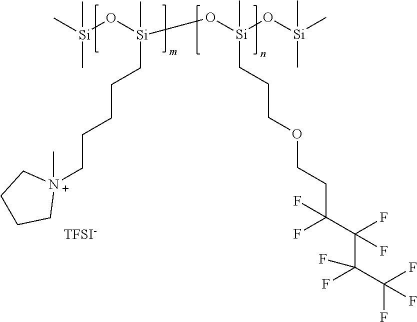

SP²_{PerF} polymer was synthesized by the reaction between siloxane-CF—Br and N-methylpyrrolidine followed by a cation exchange reaction with LiTFSI. Siloxane-CF—Br (8.32 g), N-methylpyrrolidine (2.55 g, 30 mmol), and toluene (100 mL) were charged in a 250 mL three-necked flask equipped with a reflux condenser and a magnetic stirrer. After dissolution, the mixture was heated at 85° C. for 24 hours. As the reaction progressed, the insoluble product gradually formed. After 24 hours, the insoluble product was collected by filtering and washed with 50 mL toluene three times to remove the excess N-methylpyrrolidine. Then, the collected product was dissolved in methanol (50 mL) and additional N-methylpyrrolidine was added. The mixture was charged in a 250 mL three-necked flash and refluxed at 70° C. for 12 hours. After the reaction, the solution was concentrated into about 20 mL and a large amount (150 mL) of toluene was added to precipitate the product. The precipitated product was collected and dissolved in 20 mL methanol and the precipitation process was repeated three times. Then 10 mL of LiTFSI (8.6 g, 30 mmol) dissolved in methanol was added to the above methanol solution under stirring. The reaction was held at 25° C. for 1 hour and the insoluble viscous product gradually formed. After the reaction, the precipitate was collected and washed with cold methanol 3 times. The product SP²_{perF} was dried under vacuum and obtained as a transparent viscoelastic polymer (10.81 g, yield 80.5%).

Synthesis of SP²_{alkyl}. The SP²_{alkyl} polymer was synthesized by the reaction between Siloxane-C₆—Br and N-Methylpyrrolidine and then cation exchange reaction with LiTFSI, as shown in the scheme in FIG. 6B. Siloxane-C6-Br (3.13 g, 10 mmol of Bromo), N-methylpyrrolidine (1.70 g, 20 mmol) and toluene (50 mL) were charged in a 100 mL three-necked flask equipped with a reflux condenser and a magnetic stirrer. After being completely dissolved, the mixture was heated at 85° C. for 24 hours. As the reaction progressed, the insoluble product gradually formed. After 24 hours, the insoluble product was collected by filtering and washed with 50 mL toluene three times to remove the excess N-methylpyrrolidine and unreacted reagent. Then, the collected product was dissolved in methanol (50 mL) and additional N-methylpyrrolidine (0.85 g, 10 mmol) was added. The mixture was charged in a 100 mL three-necked flask and refluxed at 70° C. for 12 hours. After the reaction, the solution was concentrated into about 10 mL and a large amount (about 70 mL) of toluene was added to precipitate the product. The precipitated product was collected and dissolved in 10 mL methanol and the precipitation process was repeated three times. Then the product was dissolved in methanol. 10 mL methanol solution of LiTFSI (4.3 g, 15 mmol) was added to the methanol solution under stirring. The reaction was held at 25° C. for 1 hour and the insoluble viscous product gradually formed. After the reaction, the precipitate was collected and washed with cold methanol 3 times. The product SP²_{alkyl} was dried under vacuum and obtained as a viscoelastic polymer (4.83 g, yield 78.5%).

Other polymers were synthesized using similar reaction schemes.

### REFERENCES

The following documents and publications are referenced in the discussion above by numerals within brackets [*] and are incorporated herein by reference:
1. Whittingham, M. History, Evolution, and Future Status of Energy Storage. Proceedings of The IEEE-PIEEE 100, 1518-1534 (2012).
2. Tikekar, M. D., Choudhury, S., Tu, Z. & Archer, L. A. Design principles for electrolytes and interfaces for stable lithium-metal batteries. Nature Energy 1, 16114 (2016).
3. Cheng, X.-B., Zhang, R., Zhao, C.-Z. & Zhang, Q. Toward Safe Lithium Metal Anode in Rechargeable Batteries: A Review. Chemical Reviews 117, 10403-10473 (2017).
4. Lin, D., Liu, Y. & Cui, Y. Reviving the lithium metal anode for high-energy batteries. Nature Nanotechnology 12, 194-206 (2017).
5. Lopez, J., Mackanic, D. G., Cui, Y. & Bao, Z. Designing polymers for advanced battery chemistries. Nature Reviews Materials 4, 312-330 (2019).
6. Zhou, H., Yu, S., Liu, H. & Liu, P. Protective coatings for lithium metal anodes: Recent progress and future perspectives. Journal of Power Sources 450, 227632 (2020).
7. Liu, K. et al. Lithium Metal Anodes with an Adaptive “Solid-Liquid” Interfacial Protective Layer. Journal of the American Chemical Society 139, 4815-4820 (2017).
8. Zheng, G. et al. High-Performance Lithium Metal Negative Electrode with a Soft and Flowable Polymer Coating. ACS Energy Letters 1, 1247-1255 (2016).
9. Kong, X., Rudnicki, P. E., Choudhury, S., Bao, Z. & Qin, J. Dendrite Suppression by a Polymer Coating: A Coarse-Grained Molecular Study. Advanced Functional Materials 30, 1910138 (2020).
10. Huang, Z. et al. Effects of Polymer Coating Mechanics at Solid-Electrolyte Interphase for Stabilizing Lithium Metal Anodes. Advanced Energy Materials n/a, 2103187 (2021).
11. Yu, Z. et al. A Dynamic, Electrolyte-Blocking, and Single-Ion-Conductive Network for Stable Lithium-Metal Anodes. Joule 3, 2761-2776 (2019).
12. Tu, Z. et al. Designing Artificial Solid-Electrolyte Interphases for Single-Ion and High-Efficiency Transport in Batteries. Joule 1, 394-406 (2017).
13. Baran, M. J. et al. Diversity-oriented synthesis of polymer membranes with ion solvation cages. Nature 592, 225-231 (2021).
14. Stalin, S. et al. Ultrathin zwitterionic polymeric interphases for stable lithium metal anodes. Matter 4, 3753-3773 (2021)
15. Lang, J. et al. One-pot solution coating of high quality LiF layer to stabilize Li metal anode. Energy Storage Materials 16, 85-90 (2019).
16. Gao, Y. et al. Polymer-inorganic solid-electrolyte interphase for stable lithium metal batteries under lean electrolyte conditions. Nature Materials 18, 384-389 (2019).
17. Liu, Y. et al. Solubility-mediated sustained release enabling nitrate additive in carbonate electrolytes for stable lithium metal anode. Nature Communications 9, 3656 (2018).
18. Li, T. et al. Stable Anion-Derived Solid Electrolyte Interphase in Lithium Metal Batteries. Angewandte Chemie International Edition 60, 22683-22687 (2021).
19. Ren, X. et al. Enabling High-Voltage Lithium-Metal Batteries under Practical Conditions. Joule 3, 1662-1676 (2019).
20. Sun, J., O'Dell, L. A., Armand, M., Howlett, P. C. & Forsyth, M. Anion-Derived Solid-Electrolyte Interphase Enables Long Life Na-Ion Batteries Using Superconcentrated Ionic Liquid Electrolytes. ACS Energy Letters 6, 2481-2490 (2021).
21. Lopez, J. et al. Effects of Polymer Coatings on Electrodeposited Lithium Metal. Journal of the American Chemical Society 140, 11735-11744 (2018).
22. Volkov, A. Polydimethylsiloxane (PDMS) BT-Encyclopedia of Membranes. in (eds. Drioli, E. & Giorno, L.) 1-2 (Springer Berlin Heidelberg, 2015). doi:10.1007/978-3-642-40872-4_1400-1.
23. Marciniec, B. Hydrosilylation: a comprehensive review on recent advances. (2008).
24. Xue, Z., He, D. & Xie, X. Poly (ethylene oxide)-based electrolytes for lithium-ion batteries. J. Mater. Chem. A 3, 19218-19253 (2015).
25. Wang, X. et al. Poly (Ionic Liquid) s-in-Salt Electrolytes with Co-coordination-Assisted Lithium-Ion Transport for Safe Batteries. Joule 3, 2687-2702 (2019).
26. Huang, Z., Choudhury, S., Gong, H., Cui, Y. & Bao, Z. A Cation-Tethered Flowable Polymeric Interface for Enabling Stable Deposition of Metallic Lithium. Journal of the American Chemical Society 142, 21393-21403.
27. Wong, D. H. C. et al. Nonflammable perfluoropolyether-based electrolytes for lithium batteries. Proceedings of the National Academy of Sciences of the United States of America 111, 3327-3331 (2014).
28. Henderson, W. A. & Passerini, S. Phase Behavior of Ionic Liquid-LiX Mixtures: Pyrrolidinium Cations and TFSI-Anions. Chemistry of Materials 16, 2881-2885 (2004).
29. Pang, Q. et al. Tuning the electrolyte network structure to invoke quasi-solid state sulfur conversion and suppress lithium dendrite formation in Li—S batteries. Nature Energy 3, 783-791 (2018).
30. Yu, Z. et al. Molecular design for electrolyte solvents enabling energy-dense and long-cycling lithium metal batteries. Nature Energy 5, 526-533 (2020).
31. Etacheri, V. et al. Effect of Fluoroethylene Carbonate (FEC) on the Performance and Surface Chemistry of Si-Nanowire Li-Ion Battery Anodes. Langmuir 28, 965-976 (2012).
32. Ren, X. et al. Localized High-Concentration Sulfone Electrolytes for High-Efficiency Lithium-Metal Batteries. Chem 4, 1877-1892 (2018).
33. Xiao, J. et al. Understanding and applying coulombic efficiency in lithium metal batteries. Nature Energy 5, 561-568 (2020).
34. Yu, Z. et al. Rational solvent molecule tuning for high-performance lithium metal battery electrolytes. Nature Energy 7, 94-106 (2022).
35. Bieker, G., Winter, M. & Bieker, P. Electrochemical in situ investigations of SEI and dendrite formation on the lithium metal anode. Phys. Chem. Chem. Phys. 17, 8670-8679 (2015).
36. Cao, X., Jia, H., Xu, W. & Zhang, J.-G. Review—Localized High-Concentration Electrolytes for Lithium Batteries. Journal of The Electrochemical Society 168, 010522 (2021).
37. Wang, D. et al. Phase-Separation-Induced Porous Lithiophilic Polymer Coating for High-Efficiency Lithium Metal Batteries. Nano Letters 21, 4757-4764 (2021).
38. Zhang, K. et al. A High-Performance Lithium Metal Battery with Ion-Selective Nanofluidic Transport in a Conjugated Microporous Polymer Protective Layer. Advanced Materials 33, 2006323 (2021).
39. Cao, X. et al. Monolithic solid-electrolyte interphases formed in fluorinated orthoformate-based electrolytes minimize Li depletion and pulverization. Nature Energy 4, 796-805 (2019).
40. Cao, X. et al. Optimization of fluorinated orthoformate based electrolytes for practical high-voltage lithium metal batteries. Energy Storage Materials 34, 76-84 (2021).
41. Xue, W. et al. FSI-inspired solvent and “full fluorosulfonyl” electrolyte for 4 V class lithium-metal batteries. Energy Environ. Sci. 13, 212-220 (2020).
42. Xue, W. et al. Ultra-high-voltage Ni-rich layered cathodes in practical Li metal batteries enabled by a sulfonamide-based electrolyte. Nature Energy 6, 495-505 (2021).
43. Zhang, W. et al. Engineering Wavy-Nanostructured Anode Interphases with Fast Ion Transfer Kinetics: Toward Practical Li-Metal Full Batteries. Advanced Functional Materials 30, 2003800 (2020).
44. Li, S. et al. Synergistic Dual-Additive Electrolyte Enables Practical Lithium-Metal Batteries. Angewandte Chemie International Edition 59, 14935-14941 (2020).

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Although the present embodiments have been particularly described with reference to preferred examples thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. A salt-philic solvent-phobic (SP²) polymer coating on a anode, wherein the anode comprises lithium, sodium, silicon, or a mixture of any two or more thereof; and wherein the SP² polymer selectively transports salt over solvent and is configured to promote salt-derived SEI formation.

2. The SP² polymer coating of claim 1, resulting in enhancement of cycling performance in solvents comprising ether, carbonate, fluorinated ether, and mixtures of any two or more thereof.

3. The SP² polymer coating of claim 1, wherein the polymer coating comprises a polymer backbone including polysiloxane, polyether, polyacrylate, or a combination of any two or more thereof.

4. The SP² polymer coating of claim 3, wherein the polymer coating comprises first sidechains on the polymer backbone, the first sidechains having salt affinity to promote salt transport.

5. The SP² polymer coating of claim 4, wherein the first sidechains comprise: 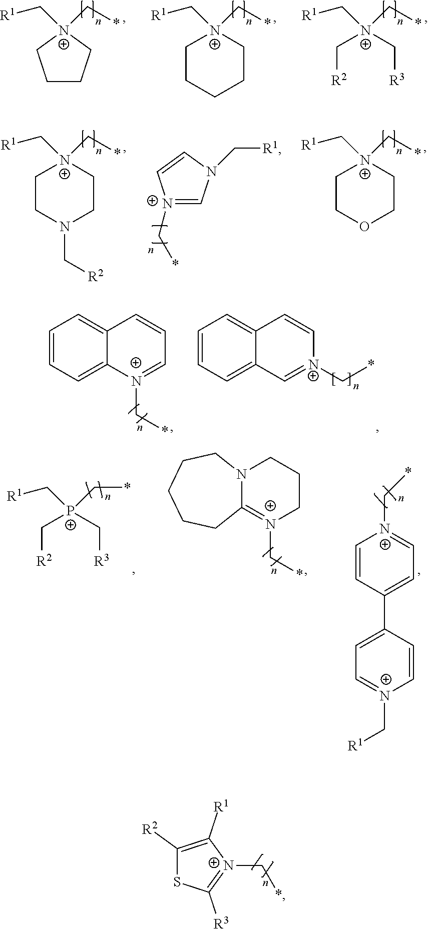
or a mixture of any two or more thereof,
wherein * indicates a point of connection to the polymer backbone;
wherein R¹, R², and R³ are each independently hydrogen, fluoride, an alkyl chain, or a fluorinated alkyl chain; and
wherein n is 1 to 100.

6. The SP² polymer coating of claim 4, wherein the first sidechains comprises: 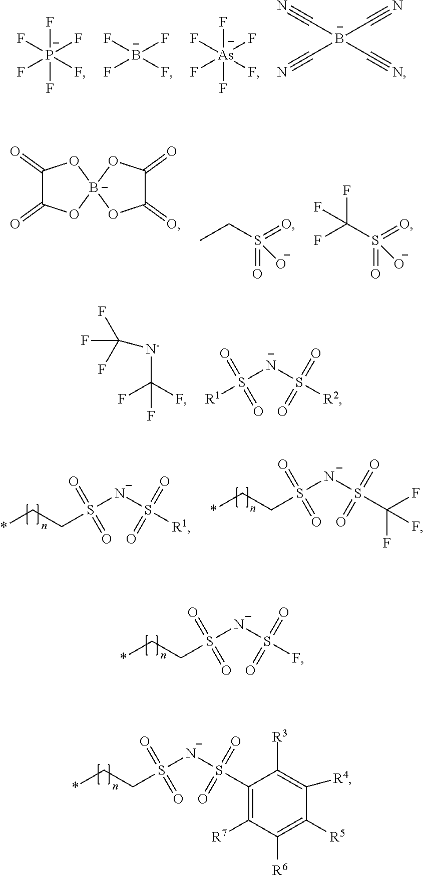
or a mixture of any two or more thereof,
wherein * indicates a point of connection to the polymer backbone;
wherein R¹ and R² are independently F, a C₁-C₁₀ alkyl chain, a C₁-C₁₀ fluorinated alkyl chain, or an aryl group;
wherein R³ to R⁷ are independently F, a C₁-C₁₀ alkyl chain, or a C₁-C₁₀ fluorinated alkyl chain; and
wherein n is 1 to 100.

7. The SP² polymer coating of claim 4, wherein the polymer coating comprises second sidechains on the polymer backbone, the second sidechains being immiscible with polar aprotic solvents.

8. The SP² polymer coating of claim 7, wherein the second sidechains comprises alkyl chains, fluorinated alkyl chains, ether, carbonate, or a combination thereof.

9. The SP² polymer coating of claim 7, wherein the second sidechains comprise 1,1,1,2,2,3,3,4,4-nonafluoro-6-propoxyhexane, hexane, or a combination thereof.

10. An electrochemical cell comprising:
an electrolyte comprising a lithium salt, a sodium salt, or a mixture thereof;
an anode comprising silicon, lithium, sodium, or a mixture thereof;
a polymer coating disposed on the anode, the polymer coating comprising:
a polymer backbone;
a first side chain comprising a first moiety having salt affinity; and
a second side chain comprising a second moiety immiscible with polar aprotic solvents.

11. The electrochemical cell of claim 10, wherein the polymer coating selectively transports salt and does not transport the polar aprotic solvents.

12. The electrochemical cell of claim 10, wherein the polymer backbone comprises polysiloxane, polyether, polyacrylate, or a combination of any two or more thereof.

13. The electrochemical cell of claim 10, wherein the lithium salt comprises lithium bis-trifluoromethanesulfonimide (LiTFSI), lithium bis(fluorosulfonyl)imide (LiFSI), lithium hexafluorophosphate (LiPF₆), lithium tetrafluoroborate (LiBF₄), lithium bis(oxalato)borate (LiBOB), or a mixture of any two or more thereof.

14. The electrochemical cell of claim 10, wherein the first moiety comprises: 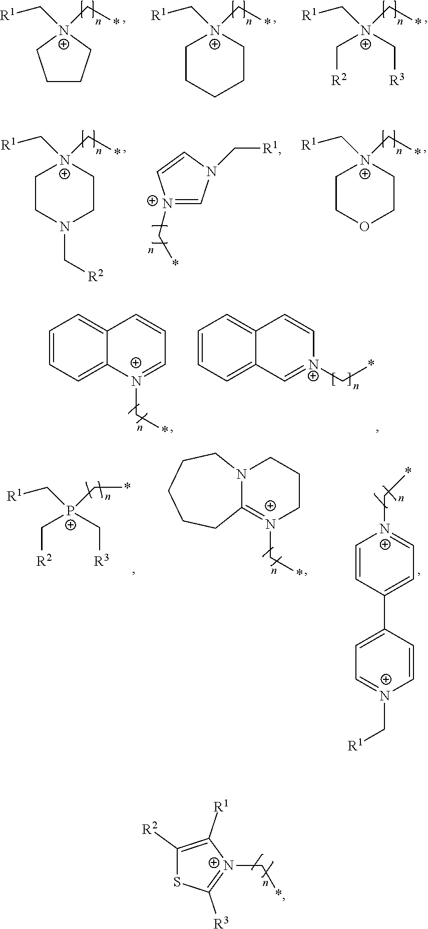
or a mixture of any two or more thereof,
wherein * indicates a point of connection to the polymer backbone;
wherein R¹, R², and R³ are each independently hydrogen, fluoride, an alkyl chain, or a fluorinated alkyl chain; and
wherein n is 1 to 100.

15. The electrochemical cell of claim 10, wherein the first moiety comprises: 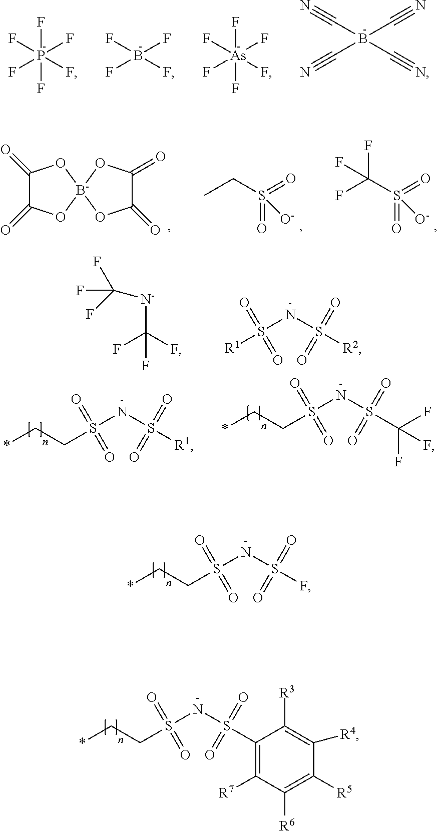
or a mixture of any two or more thereof,
wherein * indicates a point of connection to the polymer backbone;
wherein R¹ and R² are independently F, a C₁-C₁₀ alkyl chain, a C₁-C₁₀ fluorinated alkyl chain, or an aryl group;
wherein R³ to R⁷ are independently F, a C₁-C₁₀ alkyl chain, or a C₁-C₁₀ fluorinated alkyl chain; and
wherein n is 1 to 100.

16. The electrochemical cell of claim 10, wherein the first moiety comprises pyrrolidinium bis(trifluoromethylsulfonyl) imide (PyTFSI).

17. The electrochemical cell of claim 10, wherein the second moiety comprises an alkyl chain, a fluorinated alkyl chain, ether, carbonate, or a combination thereof.

18. The electrochemical cell of claim 10, wherein the second moiety comprises 1,1,1,2,2,3,3,4,4-nonafluoro-6-propoxyhexane or hexane.

19. A method of preparing a coating on a lithium anode, sodium anode, or a silicon anode, the method comprising:
spin coating or drip coating the lithium anode, sodium anode, or the silicon anode with a polymer dissolved in a solvent,
after the spin coating or the drip coating, drying the lithium anode, the sodium anode, or the silicon anode;
wherein the polymer comprises:
a polymer backbone;
a first side chain comprising a first moiety having salt affinity; and
a second side chain comprising a second moiety immiscible with polar aprotic solvents.
